(19) United States
(12) Patent Application Publication
(10) Pub. No.: US 2001/0007733 A1
(43) Pub. Date: Jul. 12, 2001

(54) Method of manufacturing color filters and liquid crystal display device using these color filters

(75) Inventors: Shigeru Matsuyama, Mobara (JP); Akira Ishii, Mobara (JP); Miyo Shimizu, Mobara (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 09/756,921

(22) Filed: Jan. 10, 2001

(30) Foreign Application Priority Data
Jan. 12, 2000 (JP) 2000-6352

(51) Int. Cl. G02F 1/1335; G02B 5/20

(52) U.S. Cl. 430/7; 349/106; 347/106

(57) ABSTRACT

After forming a black matrix which defines pixel regions on a substrate, dyed substrate layers of photo hardening property are formed. By irradiating ultraviolet rays to the dyed substrate layers from the back of the substrate and by developing, ink reservoirs which use the black matrix as partition walls are formed. The dyeing material such as the dye is supplied to these ink reservoirs by an ink jet system. Due to these partition walls, there is no possibility that the dyeing material scatters to the neighboring or adjacent pixel regions to cause the mixed color. Further, since the filters having a sufficient thickness can be formed in the ink reservoirs, the surface flatness of the color filters can be sufficiently ensured without coating the thick overcoat layer.

### BACKGROUND OF THE INVENTION

1. Field of the Invention

The present invention relates to a liquid crystal display device, and more particularly to color filters for performing a full color display, a method for manufacturing the color filters, and a liquid crystal display device using the color filters.

2.Description of the Related Art

A liquid crystal display device for a full color display includes switching elements such as electrodes and thin film transistors for selecting pixels on either one or both of two substrates and color filters in a plurality of colors (generally three colors) on the other substrate.

As a method for manufacturing these color filters, a color resist method which forms color filters in three different colors by a photolithography technique which coats a resist made of high-molecular resin material in which various pigments are dispersed on a substrate (usually, a glass substrate) and thereafter performs exposure and development by way of a mask, and a dyeing process in which dyeing materials such as dyes or pigments in various colors are supplied to a dyed substrate (also called “reception layer”) to perform dyeing have been known.

In the former method, since the resist in which a given pigment is dispersed is coated, exposed and developed for each color, that is, a so-called photolithography step is repeated to form the color filters, the process is cumbersome and there exists a limit in enhancing a throughput of products and further there may be a case that the color resist flows into or is scattered to neighboring or adjacent pixel regions thus giving rise to a mixed color.

Further, the latter dyeing process includes a method in which a sublimation dye is supplied to a dyed substrate coated onto a substrate and the sublimation dye is diffused in the dyed substrate by heating and a method in which a dyeing material such as a dye (hereinafter called “die ink” or simply “ink”), pigment or the like is supplied to a dyed substrate by an ink jet. Since the method which uses the sublimation dye is a method which performs a given dyeing by diffusing the sublimation dye in the dyed substrate layer (also called “reception layer”) based on temperature, it is difficult to make the diffusion of the dye into the dyed substrate uniform by holding the temperature distribution uniform. Accordingly, the development of a technique which can obviate the occurrence of the color irregularity (chrominance) has been a task to be solved.

On the other hand, the method adopting an ink jet method which supplies a dyeing material such as dye, pigment or the like to the dyed substrate layer by an ink jet is a method which performs coloring by permeating the dyeing material such as dye, pigment or the like to the dyed substrate. Compared to the method which uses the sublimation dye, this method suffers from less color irregularity in a display region. However, even with this ink jet method, there exists a possibility that the dyeing material such as dye, pigment or the like flows into or scatters to neighboring or adjacent pixel regions thus giving rise to a mixed color.

As mentioned above, in any one of the conventional techniques, the color resist or the dye flows into or scatters and is adhered to the neighboring or adjacent resin film or the dyed substrate and hence, a so-called “mixed color” (dyeing irregularity) is liable to occur.

For the purpose of preventing such a color irregularity, there has been a method disclosed in Japanese Laid-open Patent Publication 90342/1997 and the Japanese Laid-open Patent Publication 23833/1999. In the method, pixel regions of respective colors are partitioned using a black matrix as partition walls and “ink reservoirs “are formed in the partitioned insides (apertures of black matrix) thus preventing the intrusion of dye of other color into the partition of neighboring pixels.

However, with respect to the method which forms ink reservoirs in the black matrix, even after dyeing is completed, the black matrix is present as partition walls which are higher than respective pixel regions (color filter layers) and hence, the flatness of the surface of the color filter layers is deteriorated, whereby it is difficult to ensure the flatness of a protective film (overcoat layer), an electrode or an orientations film or the like which are formed as layers disposed above the color filter layers. To solve such a problem is another task of the present invention.

When the thickness of the overcoat layer is increased to improve the flatness, in the cell gap adjustment using sealing members which is performed at the time of adhering one substrate to the other substrate, so-called “spacers” cut into the overcoat layer and the flatness irregularity of the lower layer brings about the cell gap irregularity.

To suppress such a cell gap irregularity and ensure the sealing strength, a method which removes portions of the overcoat layer which work as backgrounds at a seal forming positions may be considered. In this case, a step for removing the thick overcoat layer becomes necessary and the uniformity of the cell gap is interrupted by scales of the overcoat layer. From this point of view, it is desirable that the thickness of the overcoat layer is reduced.

In the invention which is described in Japanese Laid-open Patent Publication 95024/1996 which adopts the back exposure, the thickness of a color filter can be leveled to a given value. However, the consideration on the color irregularity or the consideration on the thickness of the overcoat layer are not recognized in these publications.

Further, coloring (dyeing) of the dyed substrate layer is brought about in such a manner that the dyeing material such as dye, pigment or the like first permeates the dyed substrate layer and then the dyeing reaction occurs between them. Here, however, since the permeability of the dyeing material such as dye, pigment or the like into the dyed substrate layer differs every color (every dyeing material such as the dye, pigment or the like), it becomes necessary to optimize the thickness of the dyed substrate layer (amount of dyed substrate) which forms the ink reservoirs.

However, this becomes an obstacle in ensuring the flatness. That is, generally, the dyed substrate swells due to the permeation of dye and the film thickness increases. Since the degree of swelling differ in dyeing materials in respective color, even when the thickness of the dyed substrate is made equal and a sufficient amount of dyeing material made of dye, pigment or the like is supplied, the thickness of the color filter obtained after dyeing (that is, the film thickness obtained when the dyed substrate layer is dyed by the dyeing reaction) differs in respective colors.

To solve such a problem, there has been proposed a method (Japanese Laid-open Patent Publication 95024/1996) in which a sufficient amount of dye is supplied to a dyed substrate layer having light hardening property by an ink jet method for dyeing and thereafter the dyed substrate which is disposed at a side away from a substrate is developed together with dye by a back exposure which irradiates light (usually ultraviolet rays) from the substrate side and unhardened portions are removed. Due to such a method, the film thickness of the color filter formed of the dyed substrate with dye is leveled for respective colors.

This method exhibits an excellent throughput and the thickness of the formed color filter layers is made uniform so that the flatness of the color filter layers is ensured. However, the degree that the dye permeates the dyed substrate (dyeing degree) is different depending on colors and this brings about the difference in concentration of the finished color filters. As a result, it is difficult to level three colors to a given dyeing degree, that is, to make their color tone uniform so that the concentration of a specific color, for example, blue which is dyed with dye having a large molecular weight becomes high. In case of this example, among three color filters which constitute one pixel, the light transmittance of the blue color filter is decreased. Accordingly, among lights which penetrate the color filters provided to this one pixel, the intensity of blue light is decreased so that the color which this pixel displays becomes reddish relative to the color that the pixel wants to display (In other words, complementary color of blue is made strong.).

Accordingly, it is an object of the present invention to provide a method for manufacturing a color filter having a uniform color tone and a favorable surface flatness and a liquid crystal display device using such a color filter which can solve various problems which the conventional dyeing techniques adopting the color resist method or the ink jet method have suffered from.

### SUMMARY OF THE INVENTION

To achieve the above-mentioned object, according to the present invention, a pattern (usually, a light shielding film called “black matrix”) made of a resin film having a lower light transmitting property than a transparent substrate such as glass (hereinafter also simply called “substrate”) for defining pixel regions of the substrate is formed to define respective pixel regions and to form partition walls, and then, a dyed substrate having a light hardening property is coated on the insides surrounded by these partition walls (apertures of black matrix: pixel regions, also simply called “apertures”), and then a back exposure which irradiates ultraviolet rays from the back of the transparent substrate (surface at an opposite side from a coating surface of the dyed substrate) is performed on this dyed substrate layer before or after a dyeing material such as dye or pigment or the like is supplied to the dyed substrate layer by an ink jet method. Although the explanation will be made hereinafter with respect to a case in which the dye is used as the dyeing material, the same advantages are obtained in a case in which pigment or other dyeing material is used.

Since this back exposure is performed using the black matrix as the exposure mask, an unhardened portion is present at the dyed substrate having the light hardening property which is coated on an upper portion of the black matrix and an upper portion of the dyed substrate layer of the pixel region which is disposed a given distance away from a substrate surface. By removing the unhardened portion in the subsequent developing process, a hardened dyed substrate layer having a given thickness can be obtained. At the same time, the surface shape and the layer thickness of the dyed substrate layer are made uniform so that the flatness can be ensured even when an overcoat layer having a thick thickness is not coated after dyeing.

Usually, to seal two substrates, spacers are interposed on the overcoat layer and seal members (seal material) are formed on the periphery of the substrates and then the substrates are pressed together. Here, when the layer thickness of the overcoat layer which constitutes a foundation is thick, the foundation becomes softened. Accordingly, the cell gap which is adjusted by the spacers becomes irregular due to the cutting of the spacers into the overcoat layer.

To the contrary, in the present invention, since the flatness of the color filters per se is favorable, the overcoat layer which is coated on the upper layer of the color filters can be made thin so that the cell gap (the height of the gap defined between two substrates) of a liquid crystal display device can be made uniform. Further, this cell gap can be made small to a level which makes the tolerance of every lot ignored so that the display quality can be enhanced.

According to the present invention, the dyed substrate which constitutes a dye reservoir layer is coated such that the dyed substrate fills in recesses or indentations (apertures of black matrix surrounded by the partition walls) formed in the black matrix BM (resin BM) made of the resin material. As the dyed substrate, a material which advances the hardening action by the irradiation of ultraviolet rays is used. The patterning is performed on this dyed substrate layer by the back exposure which uses the black matrix as the exposure mask and the subsequent developing processing.

Accordingly, the dyed substrate layers are formed in the apertures of the black matrix in a form that the dyed substrate layers are indented lower than the height of the black matrix thereby forming ink reservoirs (openings) which use the black matrix as partition walls. The dye is supplied to these ink reservoirs by an ink jet method to store the dye on the upper portions of the dyed substrate layers and the dyed substrate is dyed in this state.

Due to such a provision, the mixed color which may be caused by the movement of the dye to the neighboring or adjacent neighboring pixels can be prevented. Further, since a sufficient amount of dye can be reserved in the ink reservoirs, by optimizing the supply amount of dye for each color, the dyeing with a given dyeing degree can be realized, whereby three colors are leveled with a given dyeing degree so that the uniform color tone can be obtained.

Further, by optimizing the layer thickness of the dyed substrate which anticipates the swelling caused by dyeing, the color filters whose height approximates the height of the partition walls of the black matrix can be formed whereby the film thickness of the overcoat layer can be made thin and the flattening becomes facilitated.

Further, in the present invention, pigment dispersed resists of given colors are respectively supplied to apertures formed by the black matrix so as to form color filters of respective colors. The same goes for when a so-called resist method is used. By applying the back exposure, the heights of the resists of respective colors can be approximated to the height of the black matrix so that the surface flatness of the color filter layer can be enhanced and the overcoat layer coated on the upper layer of the color filter layer can be made thin so that the uniform cell gap can be formed.

Further, the present invention is not limited to the color filters of the liquid crystal display device and is applicable to a similar optical film which arranges a plurality of colors.

Hereinafter, a method for manufacturing color filters according to the present invention and a typical constitution of a liquid crystal display device using these color filters are described.

With respect to the method for manufacturing color filters, following steps are performed in sequence.

(1) a first step in which on an upper portion of a first main surface (inner surface at the liquid crystal side) of a substrate used in a liquid crystal display device, a resin film having a lower light transmitting property than the substrate is formed and a plurality of apertures are formed in the resin film in a spaced-apart manner from each other,

a second step in which a material having a higher light transmitting property than the resin film and being hardened by the irradiation of light is coated on the resin film,

a third step in which light is irradiated from a second main surface opposite to the first main surface (that is, an external surface opposite to the liquid crystal layer) and hardens portions of the material,

a fourth step in which the material other than the hardened portions is removed, and

a fifth step in which dye is supplied to every apertures of the resin film and is made to permeate into the material formed for every apertures.

(2) The supply of the dye in the fifth step is performed by an ink jet method once.

(3) Dyes different in color for every apertures are supplied by an ink jet method once.

(4) The supply of the dye in the fifth step is performed in sequence for every one of a plurality of dyes.

(5) A method for manufacturing color filters is characterized by comprising following steps;

a first step in which on an upper portion of a first main surface of a substrate used in a liquid crystal display device, a resin film having a lower light transmitting property than the substrate is formed and a plurality of apertures are formed in the resin film in a spaced-apart manner from each other,

a second step in which three kinds of materials having a higher light transmitting property than the light shielding resin film and being hardened by the irradiation of light and being different in color are supplied to the resin film for every apertures,

a third step in which light is irradiated from a second main surface opposite to a first main surface and hardens portions of the material, and

a fourth step in which the material other than the hardened portions is removed such that the height of the material formed for each aperture becomes lower than the height of the resin film at least at a central portion of the aperture.

The liquid crystal display device has the following constitution.

(6) The liquid crystal display device includes a pair of substrates having respective main surfaces thereof arranged such that the main surfaces face each other in an opposed manner, a liquid crystal layer sandwiched between the respective main surfaces of a pair of the substrates, a first film formed on the main surface of one of a pair of these substrates and having a plurality of apertures spaced apart from each other and being made of a first material having a lower light transmittance than a pair of these substrates, and second films formed in apertures of the first film and being made of a second material having a higher light transmittance than the first material,

the second films include at least one of three kinds of dyeing materials different in color for each aperture of the first film and are classified into three groups consisting of a first kind group, a second kind group and a third kind group corresponding to kinds of the contained dyeing materials,

the first kind group and the second kind group of the second film include regions in the inside of the apertures of the first film which are thinner than the first film which forms the apertures,

the third kind group of the second film include regions within the apertures of the first film which are thicker than the first film which forms the apertures, and

the thickness of at least one kind group of the second film in the inside of the apertures of the first film is made different from the thickness of the other kind groups of the second film.

(7) The liquid crystal display device includes a pair of substrates having respective main surfaces thereof arranged such that the main surfaces face each other in an opposed manner, a liquid crystal layer sandwiched between the respective main surfaces of a pair of the substrates, a first film formed on the main surface of one of a pair of these substrates and having a plurality of apertures spaced apart from each other and being made of a first material having a lower light transmittance than a pair of these substrates, second films formed in apertures of the first film and being made of a second material having a higher light transmittance than the first material, and a third film formed by covering upper surfaces of the first and second films and having a higher light transmittance than the first film,

the second films include at least one of three kinds of dyeing materials different in color for every apertures of the first film and are classified into three kinds of groups consisting of a first kind group, a second kind group and third kind group corresponding to kinds of the dyeing materials,

at least one kind group of the second film includes regions in the inside of the apertures of the first film which are thinner than the first film which forms the apertures,

the first kind group of the second film had the thickness thereof in the inside of the first film different from the thickness of other kind groups of the second film, and

the thickness of the third film on the first film is made thinner than the first film.

(8) The thickness of the first film in the inside of the aperture is set to the maximum thickness of at least one group of the second film in the inside of the aperture.

(9) The undulation of an upper surface of the third film is set smaller than the undulation of upper surfaces of the first film and the second film.

The operation and advantageous effects obtained by the above-mentioned constitutions of the present invention are explained in detail in conjunction with drawings.

FIG. 1 is an explanatory view showing a method for manufacturing color filters according to the present invention and one pixel of a basic structure of a color filter of a liquid crystal display device manufactured by the manufacturing method using an ink jet method.

The liquid crystal display device is constituted by adhering respective first main surfaces (opposing surfaces) of one substrate not shown in the drawing (for example, a thin film transistor substrate) SUB1 of a pair of substrates and a color filter substrate SUB2 which constitutes the other substrate SUB2. FIG. 1(a) shows a cross section of the state in which a black matrix BM having apertures which is formed by a first film made of a resin film having smaller light transmittance than the substrate SUB2 is, first of all, formed on the main surface (first main surface: inner surface which faces the thin film transistor substrate in an opposed manner) of the substrate SUB2 which constitutes the color filter substrate.

A dyed substrate DPX which is a material having higher light transmitting property than the black matrix BM and being hardened by the light irradiation and constitutes a second film is coated on the apertures of the black matrix BM((b) of FIG.

After coating the dyed substrate DPX, ultraviolet rays are irradiated to the dyed substrate DPX from a back (second main surface) side of the substrate (so-called “back exposure”) and then the dyed substrate DPX is developed and removed together with the dyed substrate adhered to an upper portion of the black matrix such that the dyed substrate DPX remains at a level that the height of the dyed substrate DPX is lower than the height of the black matrix BM (that is, ultraviolet rays being irradiated with energy which makes a bridge reaction by ultraviolet rays generated at a level equal to or below the height of the black matrix) ((c) of FIG. 1).

On upper surfaces of the dyed substrate layers DP, ink reservoirs POD are formed using the black matrix BM as partition walls. Generally, the dyed substrate has a lower bridging density and a lower specific gravity than the black matrix material.

Dye (ink) INK is supplied to the ink reservoirs (apertures) POD by an ink jet. The supplied ink INK is prevented from flowing out to neighboring pixels due to the black matrix BM which constitutes the partition walls. The dye ink INK permeates the dyed substrate layer DP which constitutes a background of the ink INK and dyes the dyed substrate layer DP in a given color. When the equilibrium state is obtained, that is, when the dyeing of the dyed substrate is sufficiently performed, the dyeing reaction is completed. At this point of time, due to the difference of the molecular weight of the dye ink INK, the difference exists in swelling of the dyed substrate DP and the height of some ink may become higher than the height of the black matrix BM ((d) of FIG. 1). However, by performing a post baking, the height of the dyed substrate DP becomes low as shown in FIG. 1(e) and there is no possibility that the dyed substrate DP becomes extremely high. Table 1 shows the difference of molecular weight of the ink and FIG. 2 shows the difference of the dyeing degree of dyed substrate made of three respective colors (RED, GREEN, BLUE).

TABLE 1

| | ITEM | | |
|---|---|---|---|
| | | | MOLECULAR |
| COLOR | PRODUCT NAME | COMPOSITION | WEIGHT |
| RED | PC RED 136P | AZO SYSTEM | ABOUT 900 |
| | PRODUCT OF | | |
| | NIPPON KAYAKU | | |
| GREEN | PC GREEN FOP | COPPER COMPLEX | ABOUT 1100 |
| | PRODUCT OF | SALT | |
| | NIPPON KAYAKU | AZO SYSTEM | |
| BLUE | PC BLUE 43P | | |
| | PRODUCT OF | ANTHRAQUINONE | ABOUT 600 |
| | NIPPON KAYAKU | SYSTEM | |

In Table 1, the product names, the composition and the molecular weight of typical dyes (ink) of red (RED), green (GREEN), blue(BLUE) which are currently available are shown. As can be understood from the Table 1, since the ink of green (GREEN) has the largest molecular weight, in the dyeing equilibrium state of dyeing shown in FIG. 3, the swelling amount of the green color filter FIL (G) becomes largest and hence, the height of the filter becomes the largest.

FIG. 3 is a schematic cross sectional view showing color filters formed by using three dyes shown in Table 1. In the drawing, OC indicates an overcoat film and some difference in height is recognized with respect to the undulation of upper surfaces of the color filters FIL(R), FIL(G) and FIL(B) in three colors due to the above-mentioned molecular weights of INK. Then, even when a post baking is performed, the difference in height shown in the drawing remains. As a result, although the undulation remains due to the height of respective color filters and the black matrix BM, no extreme difference is present. Accordingly, even when the overcoat film OC which is formed by covering the color filters and the black matrix is made thin, the undulation of the inner surface of the color filter substrate can be made smaller than the above-mentioned undulation.

FIG. 4 is a schematic cross-sectional view showing a first example of the state in which ink reservoirs are formed by coating the dyed substrate onto a color filter substrate provided with a black matrix and FIG. 5 is a schematic cross-sectional view showing a second example of the above-mentioned state. FIG. 4 shows the case in which the wettability between the black matrix BM and the dyed substrate layer DP is not favorable and FIG. 5 shows the case in which the wettability between the black matrix BM and the dyed substrate layer DP is favorable. In the drawings, t_{BM} indicates the height of the black matrix BM, t_{CF} indicates the height of the dyed substrate layer DP at the central portion of the aperture, and t_{CF′}indicates the height of the dyed substrate layer DP in the vicinity of the black matrix BM.

As shown in FIG. 4, when the wettability between the black matrix BM and the dyed substrate layer DP is not favorable, the dyed substrate layer DP coated on the aperture of the black matrix BM is formed such that the height t_{CF} of the dyed substrate layer DP at the central portion of the aperture is larger than the height t_{CF′}of a portion of the dyed substrate layer DP which comes into contact with the black matrix BM.

To the contrary, as shown in FIG. 5, when the wettability between the black matrix BM and the dyed substrate layer DP is favorable, the dyed substrate layer DP coated on the aperture of the black matrix BM is formed such that the height t_{CF} of the dyed substrate layer DP at the central portion of the aperture is smaller than the height t_{CF′}of a portion of the dyed substrate layer DP which comes into contact with the black matrix BM.

In either case, since the black matrix BM constitutes the partition walls which form the apertures (pixel regions), the dyed substrate layer DP portions become the indentations thus forming ink reservoirs. Due to the formation of these ink reservoirs, the occurrence of mixed color caused by the flowing into or permeating or scattering of the supplied ink into the neighboring or adjacent pixels (apertures) can be obviated. Further, as mentioned previously, since the color irregularity is determined corresponding to an ink amount supplied to the dyed substrate layer, by forming such ink reservoirs, a sufficient amount of ink can be supplied to the dyed substrate layers corresponding to respective colors so that the occurrence of color irregularity can be prevented thus enhancing the color balance of the whole display screen.

Present invention is not limited to the case which uses the above mentioned dyed substrate and dyes (ink). That is, even when color filters are formed by coating color resist, the shapes shown in FIG. 4 and FIG. 5 can be obtained due to the difference of wettability between the black matrix BM and the color resist. Method for supplying the color resist to the pixel portions may be performed such that the color resist in three colors are supplied simultaneously or one by one by an ink jet.

In the case that the color resist is used, when unnecessary portion of the color resist due to the back exposure is removed, by making the height of color resist remaining as the color filters approximately equal to the height of the black matrix BM, the undulation of the upper surfaces of color filters can be suppressed so that even when the overcoat film which is coated thereafter is made thin, the flatness can be enhanced.

FIG. 6 is a schematic cross-sectional view of a case that color filters are formed by using color resists in apertures using a black matrix as partition walls. In this case, the color resists in respective colors are formed in the apertures such that their height becomes higher than the height of the black matrix BM. Here, even when a resist E in other color is adhered to the coated surface, since portions indicated by a dotted line in the drawing are removed together with the color resists coated on the upper portion of the black matrix BM by the back exposure, there is no possibility that the mixed color occurs. Then as mentioned previously, the height of respective color filters R, G, B and the height of the black matrix BM can be made substantially equal so that even with the coating of the thin overcoat, the sufficient flatness can be realized on the surface of the overcoat.

The dyed substrate layers swell during the dyeing step and shrink in the subsequent heat treatment (post baking) step. In these sequential steps, the volume of the dyed substrate layer changes corresponding to the molecular weight of the dye (ink). However, in the dyed substrate layers whose dimensions in height are leveled due to the back exposure, the dimensional irregularity on different colors after dyeing hardly occurs. For example, a method in which dyes in respective colors are chosen as shown in the previously mentioned table 1 so that the irregularity of the molecular weight is restricted within the range of 500-1500 may be taken.

The swelling of the dyed substrate layers by dyeing also depends on the combination of “resin film of dyed substrate layer×dye concentration”. Further, such swelling also depends on the combination of “the kind and number of functional group of resin which forms dyed substrate layer×the kind and number of the functional group of dye”.

Due to the above mentioned former combination, when the dyed substrate layers are formed while being leveled in a given shape by the back exposure before dyeing and the dye is diluted to the concentration suitable for the dyed substrate layer and is supplied to every apertures of the black matrix, the filter layer structure which can prevent “color irregularity” and is suitable for “surface flattening of the uppermost layer of the main surface of the color filter substrate” can be manufactured with favorable reproducibility.

Further, according to the above mentioned latter combination, the number and the density of the functional group (for example, —NH₂) of the resin of the dyed substrate layer corresponding to the functional group (for example, —NaSO₃) which one molecule of the dye has determine the progress (dyeing degree) of dyeing. The graph shown in FIG. 2 indicates the progress of dyeing of respective dyes illustrated in the above mentioned table 1 for the resins of the dyed substrate layers in embodiments which will be explained later.

For example, the progress of dyeing of the dyed substrate layer containing the resin having a given number of —NH₂ group in a unit volume differs between the dye having one —NaSO₃ group in one dye molecule and the dye having three —NaSO₃ in one dye molecule. That is, the former dye has the larger number of bond molecules for the unit volume of the dyed substrate layer than the latter dye and hence, the dyeing degree thereof is higher than that of the latter dye.

Since the progress of this dyeing also depends on the permeation of the dye into the dyed substrate layer, the progress of the dyeing influences not only the molecular structure of the dyed substrate layer but also the density, the degree of polymerization and the degree of bridging. Followings (1)-(5) are features of the present invention.

(1) As explained with respect to FIG. 4 and FIG. 5, the first main surfaces (inner surfaces which face the thin film transistor substrate SUB1 in an opposed manner) of the color filter substrate SUB2 are separated for every apertures of the black matrix BM. Accordingly, the dyed substrate layers are separated. With respect the dyed substrate layers for every apertures, the height t_{CF} of at least one kind of the dyed substrate in the inside of the aperture is different from the height of the dyed substrate of the other kind of dyed substrate layer. That is, the dyed substrate layers different in colors (different in kinds) are present on the substrate for every apertures of the black matrix BM (Assuming that the color filters are made of the color filters FIL (R), FIL (G), FIL (B) in three colors, the height t_{CF} of respective color filters FIL (R), FIL (G), FIL (B) at the inside of the apertures are all different). Here, “inside of the apertures” means the position or the region which is disposed a given distance away from the partition walls of the black matrix BM which surrounds the apertures.

FIG. 7 is an explanatory view for defining “inside of the aperture” according to the present invention and is a schematic plan view of the substrate as seen from the black matrix BM side. In the drawing, 1_{S} indicates the length of the short sides of the color filter FIL and 1_{L} indicates the length of the long sides of the color filter FIL. The region INR which respectively expands symmetrically from the center portion CTR of the color filter FIL by 1_{S}/4, 1_{L}/4 is defined as the “inside of the aperture” and its thickness is compared.

Further, FIG. 8 is a schematic cross-sectional view explaining the manufacturing process of the color filter structure in case the black matrix and the dyed substrate layers are both hydrophobic and FIG. 9 is a schematic cross-sectional view explaining the manufacturing step of the color filter structure in case the black matrix and the dyed substrate layers are both hydrophilic.

(2) As shown in FIG. 8 and FIG. 9, at least two kinds (two groups) of dyed substrate layers among at least three kinds of dyed substrate layers (groups) have the regions which do not exceed the height of the apertures which surround these dyed substrate layers in the inside of the apertures of dyed substrate layers respectively corresponding to two kinds of dyed substrate layers (t_{BM}>t_{CF} shown in FIG. 8(a) and FIG. 9(b)).

(3) Further, at least one kind of dyed substrate layer (one group) of the above mentioned three kinds of dyed substrate layers (groups) has a region where the height thereof is equal to or more than the height of the aperture which surrounds dyed substrate layer within the aperture of the dyed substrate layer corresponding to one kind of dyed substrate layer (t_{BM}≦t_{CF} shown in FIG. 8(a) and FIG. 9(b)).

(4) Further, at least one kind of dyed substrate layer (one group) of the above mentioned three kinds of dyed substrate layers (groups) has a region where the height thereof does not exceed the height of the aperture which surrounds dyed substrate layer within the aperture of the dyed substrate layer corresponding to one kind of dyed substrate layer (t_{BM}>t_{CF} shown in FIG. 8(a) and FIG. 9(b)).

(5) Then, as shown in FIG. 8(b) and FIG. 9(b), the film thickness t_{OC} of the overcoat layer OC on the black matrix BM and the film thickness t_{BM} of the black matrix BM satisfy the relationship t_{OC}<t_{BM}.

Based on the above-mentioned features, following advantageous effects described in a-h can be obtained.

Due to the combination of (1)+(2)+(3),

a. The drop (difference in height) between the upper surface of the black matrix BM and the upper surfaces of the dyed substrate layers formed in every apertures of the black matrix BM after dyeing can be specified and hence, even when the overcoat film OC which covers the dyed substrate layers is made thin, the uppermost surface of the color filter substrate SUB2 can be sufficiently flattened.

b. “Color irregularity” can be eliminated (When the dyed substrate layers after coloring satisfy the above-mentioned conditions, the dyed substrate layers before coloring inevitably indents for every apertures of the black matrix BM and ink reservoirs are formed so that ink of an amount necessary for a given dyeing can be supplied to the ink reservoirs and there exists no possibility that the ink flows into the neighboring apertures to cause mixed color.).

Due to the combination of (1)+(4)+(5),

c. The light transmittance of the color filter substrates can be increased (By making the overcoat film thin, the optical loss caused by the overcoat can be minimized).

d. The generation of gas by the moisture absorption of the formed overcoat film can be suppressed. The overcoat film increases the moisture absorption amount as the thickness of the overcoat film is increased and the influence of the gas generation amount to the film forming process of the transparent electrode such as ITO becomes apparent. By forming the overcoat film having thin thickness, the generation of gas is reduced by an amount corresponding to the reduced thickness and the transparent electrode such as ITO having a good quality can be formed on the film surface of the overcoat film.

e. As explained previously, the coating formation strength of the seal members can be increased so that a desired cell gap can be surely realized. Further, in removing the overcoat film corresponding to the seal member forming portion, since the film thickness of the overcoat film per se is thin, the residue remaining at the portion can be removed to a degree that does not cause any problem in coating the sealing member.

f. In the same manner as the combination of (1)+(2)+(3), the reduction of the “color irregularity” can be effectively performed.

The combination of (1)+(2)+(3) is preferable to achieve following advantageous effect g.

g. A color filter substrate for a liquid crystal display device having the combination of (1)+(4)+(5) can be realized.

In any one of the above-mentioned advantageous effects,

h. Under the conditions which have been difficult conventionally, the uppermost surface of the inner surface (first main surface) of the color filter substrate can be flattened (By coating the undulation of the upper surface of the dyed substrate with the overcoat film, the undulation of the upper surface of the overcoat film becomes smaller than the undulation of the upper surface of the dyed substrate.).

Besides the above-mentioned constitutions, the present invention also has following features.

(6) The dyed substrate layers is made of a material which is hardened by the irradiation of the light (chemical beams such as ultraviolet rays). The material which is hardened by the light irradiation is preferable to form the dyed substrate layers which are separated for every apertures of the black matrix using the back exposure and the development.

(7) The dyed substrate layers include residue of “photoinitiator” (catalytic substance for triggering the polymerization due to the back exposure) in the resin which forms the dyed substrate layers. The photoinitiator generates radicals and decomposes at the time of the back exposure (the skeleton of the molecules of light starting per se hardly remains ). To express this in a reverse way, when the step for forming the dyed substrate layers by the back exposure is performed and the polymerization of the resin of the dyed substrate layers progresses as expected, the residue (residual product or decomposed product) of the photoinitiator remains in the dyed substrate layers after dyeing. This residue can be detected as fragment ions when a mass spectrometer (particularly, Molecular—SIMS, First Atom Bombardment—Ionization type MS) is used. Here, SIMS is an abbreviation of Secondary Ion Mass Spectrometer.

Although the fundamental concept of the present invention and the advantageous effect thereof have been described heretofore, the present invention is not limited to the above. Further, the present invention is not limited to the constitution of embodiments which will be explained later, various modification can be made without departing from the technical concept of the present invention.

For example, as means for supplying a suitable amount of dye liquid (ink) to every pixels, a dispenser provided with a nozzle or a syringe provided with a hollow needle may be used in place of the above-mentioned ink jet method to realize the present invention.

This is because that problems such as color irregularity (Chrominance) which occurs in the color filter manufacturing step using the conventional ink jet method which has been explained heretofore may occur in the steps for dropping a given amount of dyeing liquid for every pixels using the nozzle or the hollow needle.

As the previously mentioned dispenser, a device which is used in coating a sealing agent for a liquid crystal panel is known. However, in the manufacturing of the color filters, it is recommendable to use a device called micro dispensers which can meet the conditions for micro processing.

Further, a method which supplies a given amount of liquid substance by means of an ink jet method or a micro dispenser or the like may be applicable not only to the dyeing liquid but also to a coloring substrate (being in the liquid state before being hardened).

### BRIEF DESCRIPTION OF THE DRAWINGS

FIG. 1 is an explanatory view showing a method for manufacturing color filters and one pixel of a fundamental structure of a color filter of a liquid crystal display device manufactured by this manufacturing method using an ink jet method.

FIG. 2 is an explanatory view showing the difference of dyeing degree of the dyed substrate by respective ink in three colors (RED, GREEN, BLUE).

FIG. 3 is a schematic cross-sectional view of a color filter formed by using three dyes shown in Table 1.

FIG. 4 is a schematic cross-sectional view showing a first example of the state in which ink reservoirs are formed by coating the dyed substrate to a color filter substrate provided with a black matrix.

FIG. 5 is a schematic cross-sectional view showing a second example of the state in which ink reservoirs are formed by coating the dyed substrate to a color filter substrate provided with a black matrix.

FIG. 6 is a schematic cross-sectional view of a case in which color filters are formed using color resist at apertures which use the black matrix as partition walls.

FIG. 7 is an explanatory view for defining “inside of apertures” according to the present invention and is a schematic plan view of a substrate as seen from the black matrix BM side.

FIG. 8 is a schematic cross-sectional view explaining a step for manufacturing the color filter structure when a black matrix and dyed substrate layer are both hydrophobic.

FIG. 9 is a schematic cross-sectional view explaining a step for manufacturing the color filter structure when a black matrix and dyed substrate layer are both hydrophilic.

FIG. 10 is a schematic process view showing the first embodiment of a method for manufacturing color filters according to the present invention.

FIG. 11 is a cross-sectional structural view corresponding to an essential part of the schematic step for further explaining the first embodiment of a method for manufacturing color filters according to the present invention.

FIG. 12 is a cross-sectional structural view corresponding to an essential part of a schematic step of the method for manufacturing color filters succeeding the step shown in FIG. 11.

FIG. 13 is a schematic process view showing the second embodiment of a method for manufacturing color filters according to the present invention.

FIG. 14 is a schematic cross-sectional view of color filter substrates in the state that an overcoat layer is coated after developing.

FIG. 15 is a schematic process view for explaining the fourth embodiment of a method for manufacturing color filters of the present invention.

FIG. 16 is an explanatory view of a dyeing step of the fourth embodiment of a method for manufacturing color filters of the present invention.

FIG. 17 is a schematic process view for explaining the sixth embodiment of a method for manufacturing color filters of the present invention.

FIG. 18 is an explanatory view of a dyed substrate layer which has made a surface thereof coarse by a plasma ashing.

FIG. 19 is a schematic process view for explaining the seventh embodiment of a method for manufacturing color filters of the present invention.

FIG. 20 is a schematic process view for explaining the first partition wall forming method according to the seventh embodiment of the present invention.

FIG. 21 is a schematic process view for explaining the second partition wall forming method according to the seventh embodiment of the present invention.

FIG. 22 is a schematic cross-sectional view of color filters obtained by forming dyed substrate layer on the substrate provided with partition walls of the embodiment shown in FIG. 19 and dyeing with the dyes.

FIG. 23 is a schematic cross-sectional view for explaining a color filter substrate of the eighth embodiment of the present invention.

FIG. 24 is a schematic cross-sectional view showing the state in which color filters are formed on apertures of a black matrix having partition walls explained in FIG. 23 and an overcoat OC is coated thereon.

FIG. 25 is a developed perspective view for explaining one constitutional example of a liquid crystal display device to which the present invention is applied.

FIG. 26 is an explanatory view of an outer structure of a liquid crystal display module which integrates a liquid crystal display panel of a liquid crystal display device together with a back light by means of an upper frame and a lower frame.

FIG. 27 is a perspective view of a notebook type computer for explaining the mounting example of the liquid crystal display device shown in FIG. 26.

FIG. 28 is a plan view for explaining one pixel and the constitution around the pixel of a liquid crystal display device adopting a thin film transistor system to which the present invention is applied.

FIG. 29 is a cross-sectional view taken along a line 3-3 of FIG. 28.

FIG. 30 is a wiring diagram of an equivalent circuit and a peripheral circuit of a liquid crystal display device.

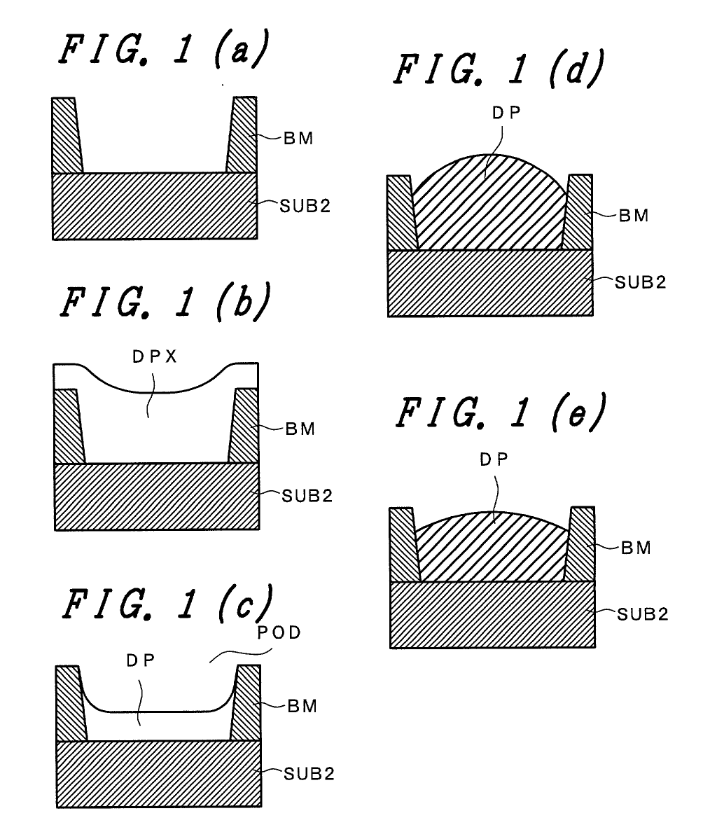

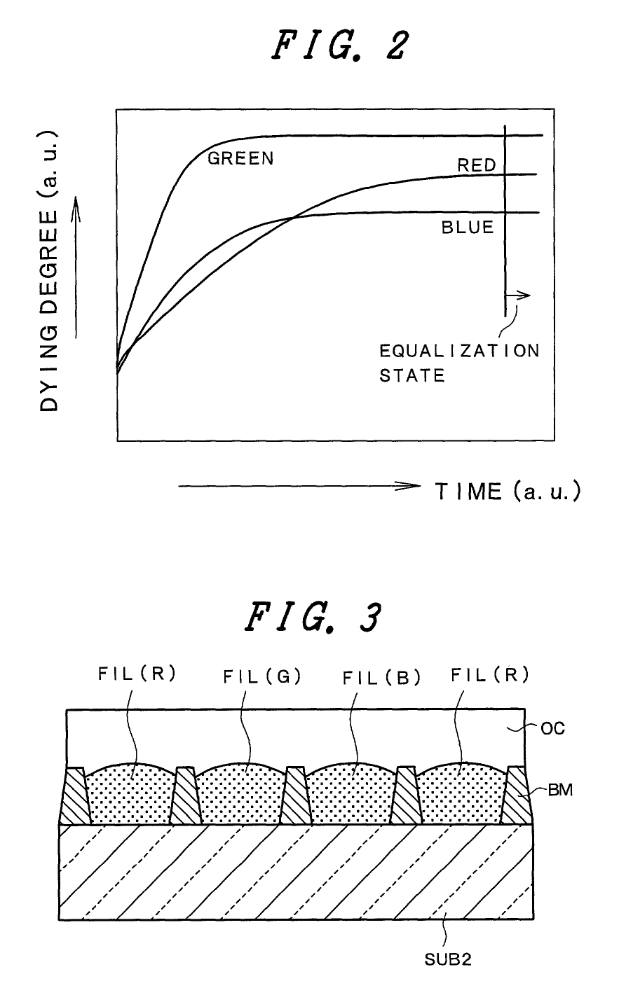

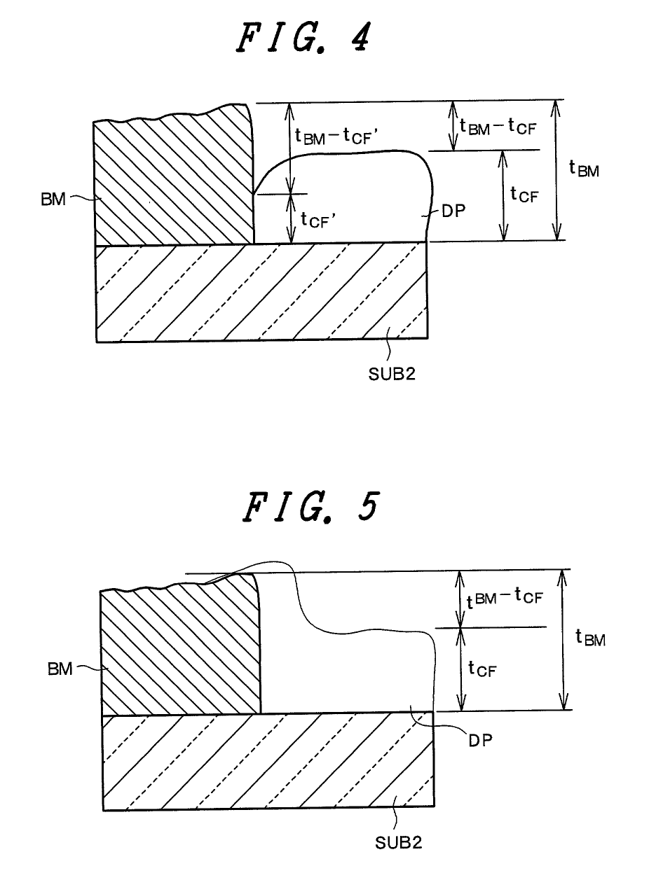

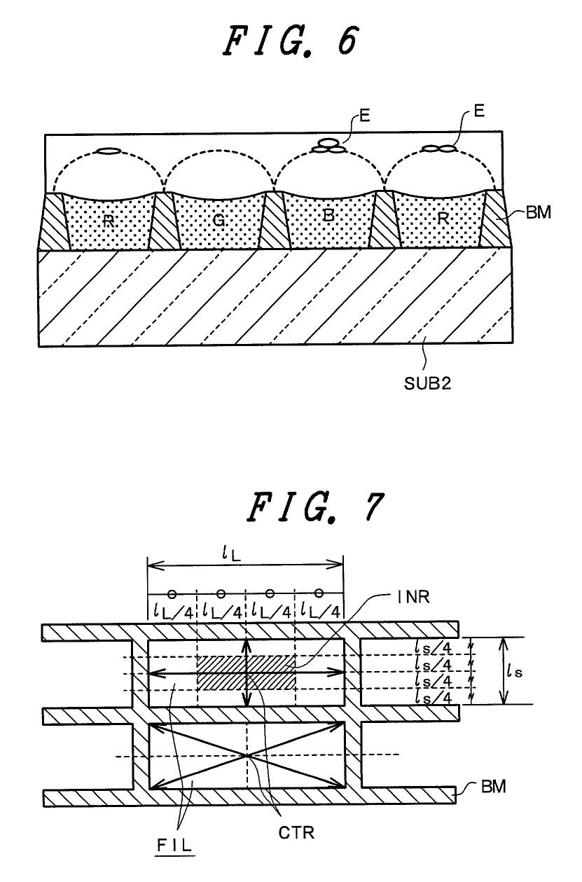

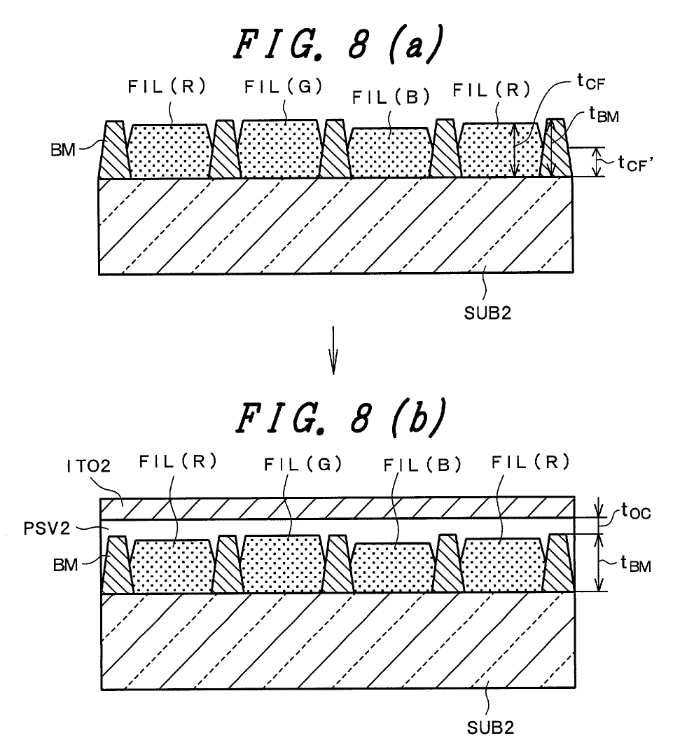

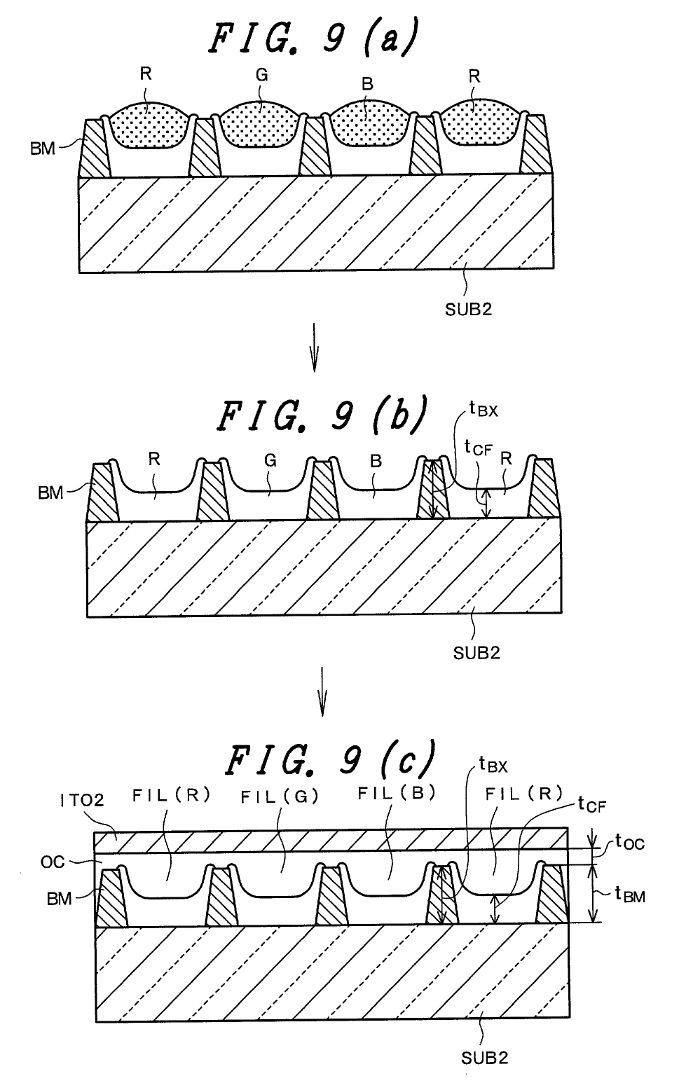

### PREFERRED EMBODIMENTS OF THE INVENTION

Embodiments of the present invention are explained hereinafter in conjunction with drawings.

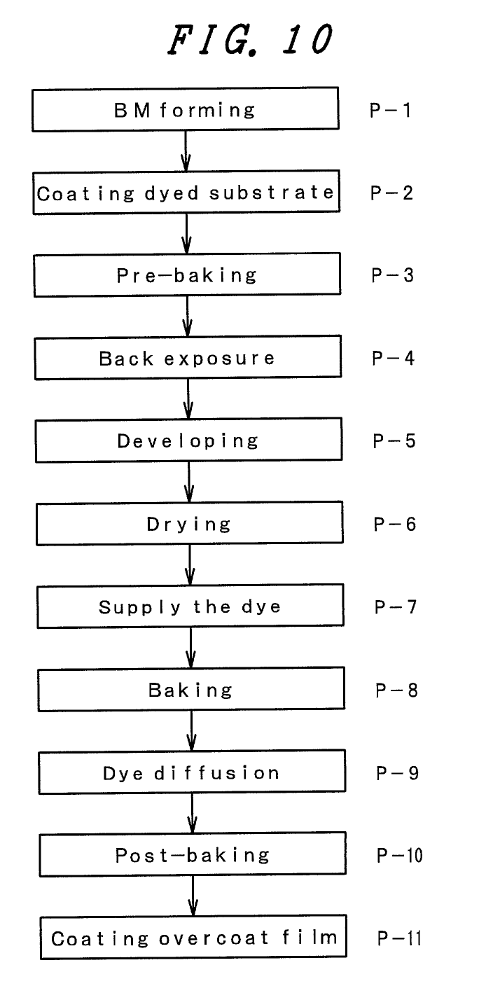

FIG. 10 is a schematic process view for explaining the first embodiment of a color filter manufacturing method according to the present invention. In this embodiment, partition walls are formed of a black matrix made of a resin material for every pixels (pixel regions corresponding to color filters in respective colors). In aperture portions formed by these partition walls, indentations (ink reservoirs) are formed by dyed substrates to enable the supply of ink.

That is, on a first main surface of a glass substrate which constitutes a color filter substrate, a resist which disperses a black material such as graphite or metal oxide or the like in polymeric resin is coated. The resist is exposed through an exposure mask and developed to form a black matrix BM having given apertures (process-1, hereinafter abbreviated to P-1). In this embodiment, the film thickness of the black matrix BM is 1.4 μm and its optical density (OD value) is 3.7. As the material of the black matrix BM, “BK series” produced by Tokyo Ouka Kabushiki Kaisha or “DCF-K series” produced by Nihon Kayaku Kabushiki Kaisha (hereinafter called Nihon Kayaku (Kabu) or Nihon Kayaku) was used.

A dyed substrate which forms reservoir layers is coated onto the apertures of the black matrix BM using a spinner (P-2) and a pre-baking is applied to the dyed substrate (P-3). As the dyed substrate, “CFR-633L1” or “CFR-633DHP” (both product names) produced by Nihon Kayaku (Kabu) was used. The dyed substrate has a lower bridging density than the material of the black matrix BM and the specific gravity thereof is also lower than that of the black matrix BM. When such dyed substrate was used, the rotational speed of the spinner was set to 800 rpm and the film thickness of the dyed substrate obtained after performing the pre-baking treatment for 10 minutes at a temperature of 80° C using a hot plate was set to 1.45 μm.

Subsequently, from a second main surface opposite to the first main surface of the substrate, the back exposure is performed at the wavelength of 365 nm and with energy of 200 mj/cm² using a super high pressure mercury discharge lamp (P-4). In this back exposure, the black mask BM is used as an exposure mask so that the exposure light is not irradiated to portions of the dyed substrate coated on the first main surface which are disposed above the black matrix BM. The irradiation energy of the exposure light hardens the dyed substrate of the aperture portions uniformly at every apertures and only portions lower than the height of the black matrix BM. Unhardened dyed substrate is removed by the subsequent developing so as to form the indentations of the dyed substrate layers at the apertures of the black matrix BM (P-5). Thereafter, the dyed substrate layers are dried (P-6). This drying is performed using a so-called air knife drying method and the film thickness of the dyed substrate layers after drying was set to 1.00 μm.

The dye (ink) is supplied into the apertures of the dried black matrix BM (P-7). To supply this dye, a piezo-type ink jet printer is used. Various products are known as the dye. In this embodiment, following products were used.

red (R): Product of Nihon Kayaku (Kabushiki Kaisha) PC Red 136P . . . 0.2% aqueous solution

green (G): Product of Nihon Kayaku (Kabushiki Kaisha) PC Green FOP . . . 0.1% aqueous solution

blue (B): Product of Nihon Kayaku (Kabushiki Kaisha) PC Blue 43P . . . 0.2% aqueous solution

After supplying the dye into the apertures, a drying baking was performed (P-8). This drying baking was performed for 10 minutes at a temperature of 130° C using a hot plate.

After the drying baking was completed, the color filter substrate was immersed in hot water of 70° C for 5 minutes to perform the dye diffusion processing (P-9) and then was dried using the air knife drying method. The film thickness of the dyed substrate layers after dye diffusion was as follows.

red (R): 1.51 μm

green (G): 1.63 μm

blue (B): 1.42 μm

These dyed substrate layers were subjected to a post baking at a temperature of 150° C for 1 hour using a clean oven (P-10). The film thickness of the dyed substrate layer after post baking, that is, the color filter layers was as follows.

red (R): 1.43 μm

green (G): 1.55 μm

blue (B): 1.35 μm

Finally, an overcoat film OC having a film thickness of 1.4 μm was coated on the black matrix BM and respective color filters (P-11) to complete the color filter substrate. The surface step of the overcoat layer OC was 0.1 μm. Thereafter, a liquid crystal orientation control film (a so-called orientation film) is coated on the overcoat film OC.

By making respective inner surfaces of the color filter substrate manufactured in this manner and the other substrate (for example, a thin film transistor substrate) face each other in an opposed manner and inserting a liquid crystal layer in a gap defined between these substrates, a liquid crystal display device was obtained.

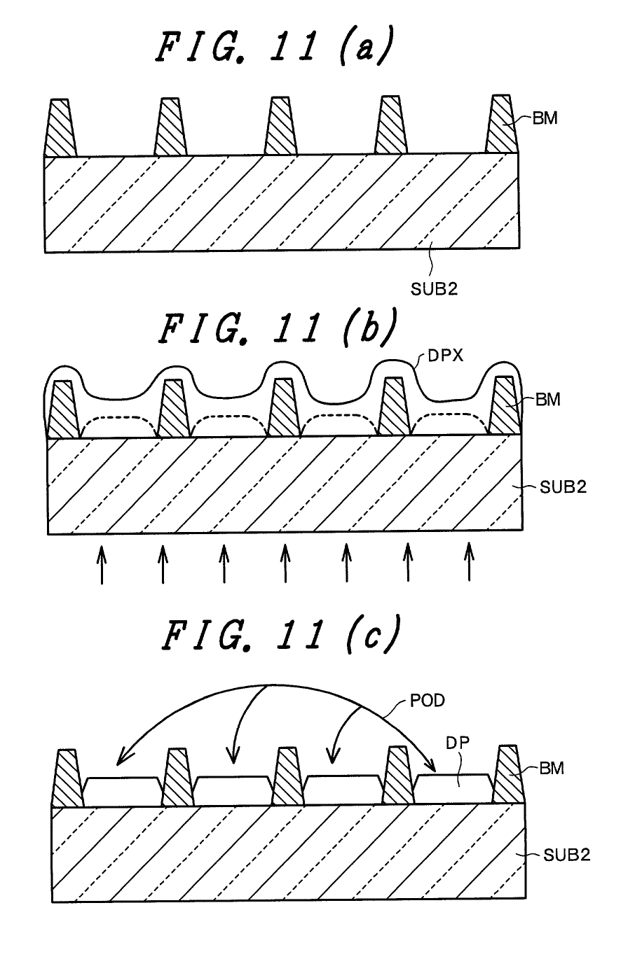

FIG. 11 is a cross-sectional structural view corresponding to an essential part of a schematic step for further explaining the first embodiment of the method for manufacturing color filters of the present invention. As a color filter substrate SUB2 which forms a pair with the other substrate (SUB1) not shown in the drawing, although depending on the type of a liquid crystal display device, generally, a soda-lime glass which forms a thin film of SiO₂ on the surface thereof is favorably used for STN and an alkalifree glass (borosilicate glass) is favorably used for thin film transistor (TFT).

On the first main surface of this substrate SUB2, the pattern of the black matrix (BM) is formed using the black resist generally called the resin BM (FIG. 11(a)).

Depending on the kinds of respective glasses, they differ in the transmittance of the light (particularly, UV rays) so that it becomes necessary to change the conditions of the back exposure or the sensitized wavelength of a photoinitiator in the dyed substrate.

In this black matrix BM, generally, the light absorption degree thereof is adjusted such that the film thickness becomes 1-2 μm. With respect to the black resist, carbon is used as pigment which is a light absorption substance to be mixed into the resin and the light shielding rate is determined by an addition amount of carbon for resin.

In the case of a liquid crystal display device of an IPS mode (transverse electric field type) which uses thin film transistors, sine the black matrix BM of high resistance becomes necessary, the pigment made of a material other than carbon, for example, metal oxide or the like is used.

In the subsequent step, on the pattern of the black matrix BM, resin (dyable material: dyeable resin) which has photoactivity (property which advances the hardening reaction by the irradiation of chemical rays such as ultraviolet rays) and can be dyed with dye (hereinafter called “ink”), that is, the dyed substrate DPX is coated. By performing the back exposure which irradiates the ultraviolet rays L from the back (the second main surface) of the substrate SUB2 (FIG. 11(b)), the dyed substrate layer DP is formed on the apertures of the black matrix BM using the BM pattern as the exposure mask (FIG. 11(c)).

In this exposure, as shown in FIG. 11(b), by adjusting the energy of ultraviolet rays, only the portions (indicated by the dotted line in the drawing) of the dyed substrate DPX whose height is lower than the height of the black matrix BM are hardened and then the developing treatment is performed. Accordingly, as shown in FIG. 11(c), the unhardened portions are removed together with portions hidden by the black matrix BM and the dyed substrate layers DP having lower height than the black matrix BM are formed using the black matrix BM as partition walls. In the drawing, POD indicates the indentations constituted in the apertures of the black matrix BM, that is, ink reservoirs. Further, it is enough to form the dyed substrate layers only at the display regions (pixel regions) and portions other than such display regions (periphery of the display regions) are shielded from light with a frame-like mask in the developing step whereby the dyed substrate in the periphery of the display regions are removed.

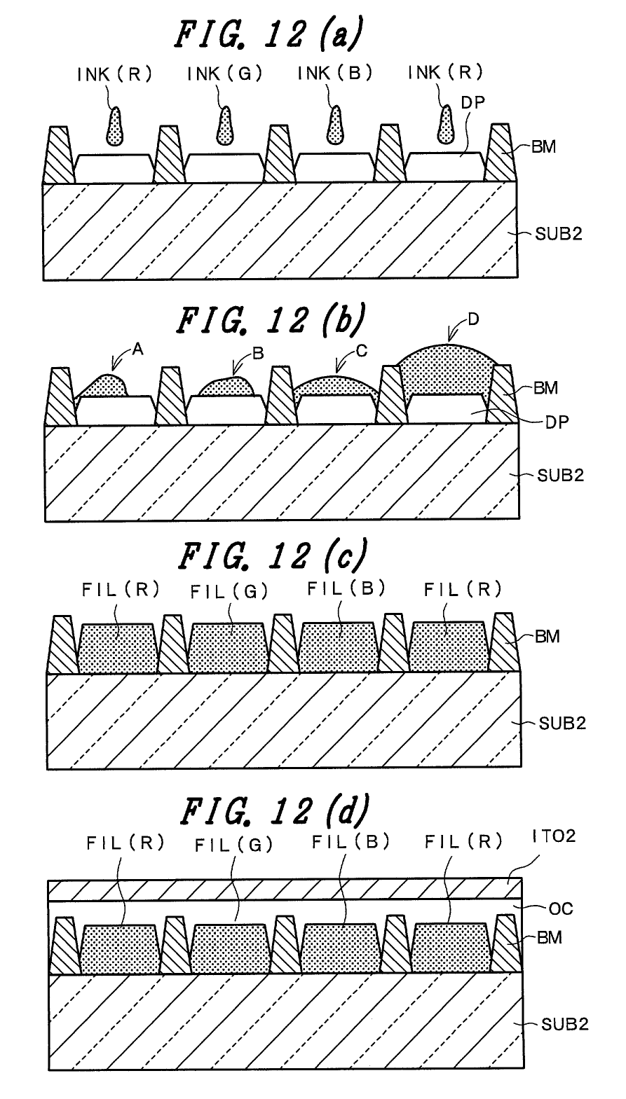

FIG. 12 indicates a cross-sectional structural view corresponding to an essential part of a schematic step of a method for manufacturing color filters which follows the step of FIG. 11. INK (R), INK (G), INK (B) which correspond to respective colors are supplied to respective ink reservoirs POD by an ink jet method (FIG. 12(a)). FIG. 12(b) explains the various shapes of ink supplied to the ink reservoirs POD irrelevant to the kind of color of the pixels. In the drawing, the supply of ink is performed simultaneously with various resultant shapes A,B,C,D. The dyeing of the dyed substrate layers DP can achieve the desired dyeing degree when the sufficient amount of ink is supplied since the dyeing becomes equalized. Accordingly, with the ink amount shown by A and B, there arises a case that a sufficient dyeing cannot be obtained. If the control of a dropping amount of ink from an ink jet nozzle can be performed with high accuracy, it is desirable to cover the whole of the ink reservoir with ink as indicated by C. However, it is difficult to perform such supply of ink on the whole pixels (ink reservoirs POD).

Accordingly, in this embodiment, as indicated by Din FIG. 12(b), ink is raised on the dyed substrate layer DP making use of the surface tension of the ink. This can be realized by adopting a structure where the black matrix BM is used as the partition walls and the height of the dyed material substrate layer DP is made lower than the height of the black matrix BM.

FIG. 12(c) shows the state that ink INK (R), INK (G), INK (B) in respective colors are supplied as indicated by D in FIG. 12(b) to dye the dyed substrate layer DP to form color filters FIL (R), FIL (G), FIL (B) respectively. This dyeing is performed as the ink diffuses into the dyed substrate layers DP. As a method which makes the ink diffuse into the dyed substrate layers DP, a method which heats the dyed substrate layers DP is desirable. As a heating method, heating by hot water, heating by steam and heating in air are all available.

After dyeing, the dyed substrate layer DP swells due to the diffusion of ink. Since the molecular weights of ink in respective colors are different, their swelling amount also becomes different. However, by increasing the bridging density in the subsequent post baking, they shrink and the height of the color filters FIL (R), FIL (G), FIL (B) from the substrate may be slightly different from each other but the difference in height is much smaller than the conventional color filters. Accordingly, in the drawing, the color filters are shown without specifically distinguishing the difference in height.

After forming the color filters FIL (R), FIL (G), FIL (B), they are coated by an overcoat layer OC which is called a flattening protective film and then the overcoat layer OC is hardened to flatten the uppermost surface of the color filter substrates. Although it is unnecessary in the color filter substrates using thin film transistors of IPS type, in case of the color filter substrate used in a liquid crystal display device adopting the STN type, or in the liquid crystal display device adopting the TN type or the MVA type, a transparent conductive film ITO2 is formed on the overcoat layer OC by vapor deposition (FIG. 12(d)).

Conventionally, the overcoat layer OC requires the film thickness of equal to or more than 1-2 μm. In this embodiment, since the difference in height among the dyed substrate layers DP after dyeing is small, the film thickness of the overcoat layer OC can be made equal to or less than 1 μm.

According to the embodiment which has been explained heretofore, by adopting the structure in which by controlling the film thickness of the black matrix and the dyed substrate layers, the stepped portions where the dyed substrate layers indent (difference in height) is formed between the black matrix and the dyed substrate layers and dye (ink) is reserved in the dyed substrate layers using the black matrix as the partition walls, a sufficient amount of dye necessary for dyeing can be supplied to the dyed substrate layers while insulating dyed substrate layers from neighboring pixels so that the color filters of given color tones can be constituted.

Further, by realizing the control of the film thickness of the black matrix and the dyed substrate layers while expecting the swelling and shrinkage of the dyed substrate, the flatness of the upper surfaces of the color filters can be enhanced and the color filter substrates having favorable surface flatness can be obtained with the coating of the thin overcoat.

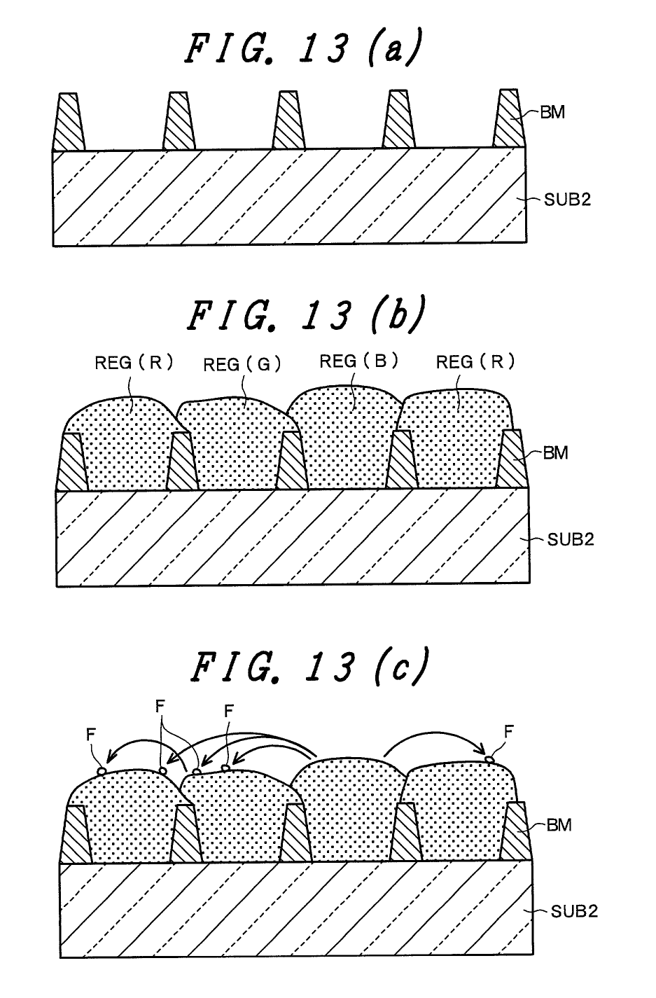

FIG. 13 is a schematic process view for explaining the second embodiment of a color filter manufacturing method of the present invention. In this embodiment, a negative-type photosensitive resin (color resist) which is preliminarily colored with pigment or dye is used. With the use of this photosensitive resin, a substrate which forms color filters corresponding to pixels in three colors by a photolithography process is obtained.

In this embodiment, a photosensitive color resist which disperses carbon as black pigment is coated on a first main surface of a color filter substrate SUB2 and then a patterning of the color resist is performed to form apertures of a black matrix BM (FIG. 13(a)).

Color resists REG (R), REG (G), REG (B) in respective colors are supplied into the apertures of the black matrix BM by an ink jet method. In supplying the color resists by the ink jet, it is difficult to control the color resists in respective colors at high accuracy for every apertures (pixels). Accordingly, the present embodiment supplies the color resists in respective colors in excessive amount (FIG. 13(b)). Although the color resists in respective colors may be simultaneously supplied, in this embodiment, these color resists are supplied one by one in sequence. At the time of supplying the color resist, there may be a case that the color resist in other color scatters and adheres to the color resist at the neighboring or adjacent pixel as fragments F (FIG. 13(c)). When these fragments F remain, it brings about the mixed color.

The pigment resist is comprised of pigment which constitutes a solid component, a resin component, additives such as a dispersion agent and a solvent. The color tone, the color density and the transmittance are determined based on the concentration of the pigment dispersed in the resin component. The resin component has high transmittance and is a component which generates bridging along with the chemical reaction such as the radical reactions or the like at the time that light is irradiated by a photoinitiator which constitutes a portion of the additives.

As the photoinitiator, due to the difference of photoactivity depending on the kinds of the photoinitiator, the material which matches each color tone used in each pixel is selected. When the ultraviolet rays are used as the exposure light, the material which exhibits the absorption in the band of relatively short wavelength is often selected.

Further, the solvent component is often added to control the viscosity of the resist material, to enhance the operability in coating and dropping or dissolving the solid matter with the resin component or the like.

After supplying the color resists to respective pixel portions (apertures) using the ink jet method, to remove the solvent component contained in the color resist as much as possible, the color resist is heated so as to perform the drying of the solvent. When the solvent remains in the resist, there is the possibility that the photobridging reaction is interrupted. Accordingly, it is necessary to perform the drying at a level that the photobridging reaction is not interrupted. To efficiently perform this drying step, the drying may be performed under the reduced pressure.

After the drying step, the light is irradiated from the back of the substrate SUB2, that is, from the second main surface of the substrate SUB2 so as to induce the hardening reaction of the color resists for respective pixels. This operation which is usually called “back exposure” has the characteristics that as the color resist is positioned closer to the substrate SUB2, the degree of linking becomes higher. Particularly, when the bridging progresses due to the radical reaction of the irradiation of ultraviolet rays, it is known that at portions which come into contact with oxygen in air, the progress of the radical reaction is restricted and hence, the progress of the bridging reaction is also restricted.

Further, since the resists are the color resists, the resists have absorption property for light which varies corresponding to respective colors so that the hardening action progresses slower compared to the transparent resin.

After the completion of the back exposure, the developing treatment is performed. In developing the color resists of pigment dispersion type, a developer which contains alkali aqueous solution as a base component and contains a surfactant as an additive is popularly used. In this embodiment, this developer is also used. In the resin component of the color resists, the functional group which is soluble to alkali is present and the solubility is high at portions where the bridging reaction has not yet progressed sufficiently. By performing the development making use of such a nature, the portions where light is shielded by the black matrix BM and the surface portions of the color resists where the progress of bridging reaction is low are removed and the portions whose height is lower than the black matrix BM remains thus completing the development (a so-called” film thickness decrease”). The degree of this film thickness decrease can be adjusted by controlling an amount of photoinitiator added to the resist, an irradiation amount of light (energy) and the wavelength.

To suppress the occurrence of the fragments explained in the above-mentioned embodiment, the viscosity of dye ink is forcibly increased so as to make the dye ink have the stickiness and the thixotropic property whereby even when the dye is excessively supplied to the aperture, the scattering of the dye to the neighboring or adjacent pixel regions can be effectively suppressed.

The dye ink contains the dye, the solvent and various additives in the constitutional material thereof. The solvent is often water. However, with respect to the dye ink used for the manufacturing of color filters, the organic solvent is often mixed into water. This organic solvent is soluble to water and the material which dissolves the dye is generally selected as the organic solvent. However, to control the drying speed of the dye ink, the solvent may be made by mixing a plurality of solvents. Further, as an additive, a surfactant which facilitates dyeing or the like can be used.

As the material which adjusts the viscosity of the dye ink, it is necessary to select the material which is soluble to the above-mentioned solvent. As the viscosity adjusting method, a method which uses the solvent having high viscosity, a method which adds polymeric material soluble to the solvent or the like is considered. To increase the viscosity, a polyhydric alcohol group such as glycerol is favorable because of their high affinity with water (hydrophilicity). Further, to increase the viscosity of the dye ink much higher, it is also effective to use a resin material which is highly soluble to an organic solvent which is water soluble or has high affinity with water (hydrophilicity). For example, a cellulose group, polyvinyl alcohol or the like can be used as such resin material. Particularly, to consider the removal of the material by cleaning after dyeing, the polyvinyl alcohol or the like which has the low degree of oxidation can obtain the most favorable result.

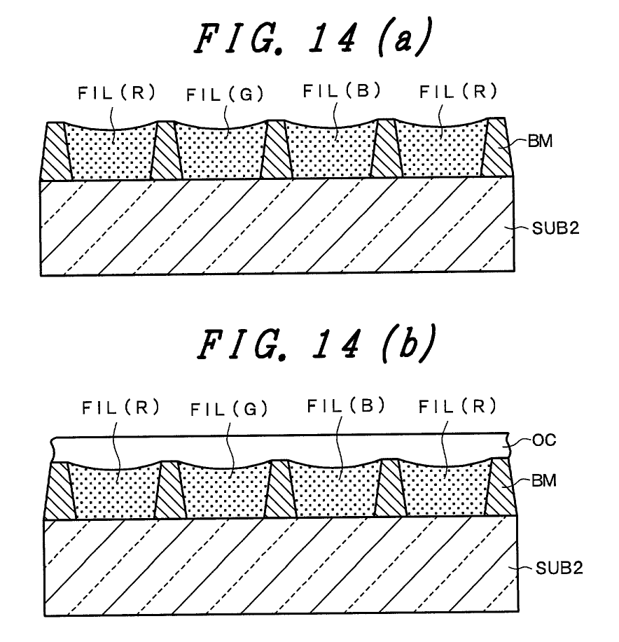

FIG. 14 is a schematic cross-sectional view of the color filter substrate in the state the developing is finished and in the state the overcoat layer is coated on the color filter substrate after developing. As shown in FIG. 14(a), due to the developing, the fragments F which have adhered to the color resist before developing are removed so that a cause of mixed color is eliminated. Accordingly, the color resist layers which have the lower height than the black matrix BM remain for every colors and these color resist layers respectively constitute the color filters in three colors FIL (R), FIL (G), FIL (B). Thereafter, these color filters are washed or rinsed with water and then are dried by heating.

To enhance the heat resistance of the color resists further, components which perform bridging by heating are filled in the color resists and the bridging is strengthened at the time of drying by heating.

After drying, the overcoat layer OC is coated to obtain the color filter substrate having the flat inner surface (FIG. 14(b)).

In the conventional color filters using the color resists, the height of the color filters are higher than the height of the black matrix BM and hence, the surface step is large. Accordingly, effort have been made to realize the surface flatness by increasing the film thickness of the overcoat layer OC.

According to this embodiment, the color filter substrate having the sufficient surface flatness can be formed with the overcoat layer OC having the thin film thickness. Accordingly, columnar spacers which are provided as spacers for forming the cell gap can be formed with a uniform height even at the overcoat layer OC and hence, a liquid crystal display device of high definition which has the uniform cell gap can be obtained.

In the IPS type, a liquid crystal orientation control layer is coated on the overcoat layer OC. However, in a liquid crystal display device adopting TN type or the like, a transparent conductive film ITO2 is formed on the overcoat layer OC by a vapor deposition and thereafter a liquid crystal orientation control layer is coated on the conductive film ITO2.

As the color resist, a color resist which uses dye may be used. When the dye is used, the dye is present in the resin in a dissolved form or is present in the solvent in an extremely small particle form. Accordingly, compared to the case that pigment is used, an action to disturb the polarization is small and hence, excellent optical characteristics can be obtained. However, this effect remarkably appears when a polarizer is mounted and so long as only the color filter is used, the difference between the dye resist and the pigment resist is not large.

Subsequently, in the above-mentioned embodiment which dyes the dyed substrate layers with the supply of dye ink, an embodiment which prevents the scattering of dye ink to neighboring or adjacent pixels thus eliminating the mixed color is explained.

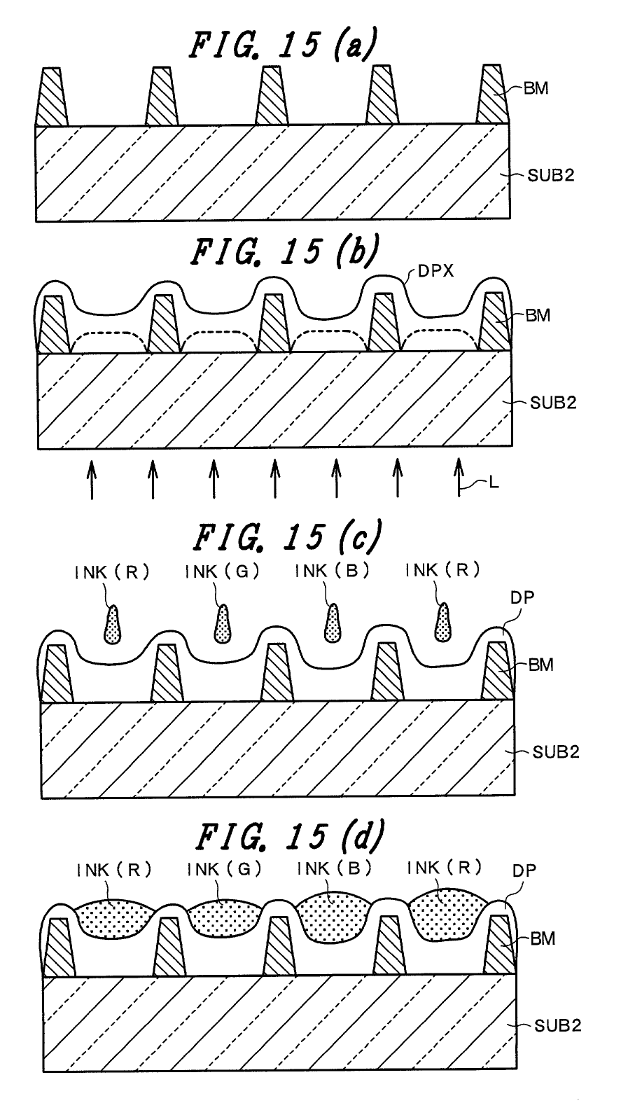

FIG. 15 is a schematic process view explaining the fourth embodiment of a color filter manufacturing method of the present invention. In this embodiment, in the same manner as the second embodiment, dyed substrate DPX is coated on apertures of a black matrix BM formed on a first main surface of a color filter substrate SUB2 (FIG. 15(a)). Here, the dyed substrate DPX is coated on the whole surface of the substrate SUB2 on which the black matrix BM is formed such that the dyed substrate DPX is positively present on an upper portion of the black matrix BM (FIG. 15(b)).

The dyed substrate DPX is a photo hardening resist which is linked and hardened by the irradiation of light as in the case of the first embodiment and is made of resin which can be patterned by a photolithography processing. In the same manner as the black matrix BM, the thickness of the film formed by coating the dyed substrate DPX is determined by a solid component concentration of the resist and the coating conditions. The film is formed by using a spinner such that the thickness of the film is similar to that of the first embodiment.

Under this state, light L is irradiated from the back of the substrate SUB2 so as to harden the dyed substrate DPX of the pixel portions using the pattern of the black matrix BM as the exposure mask.

Here, only portions of the dyed substrate DPX indicated by a dotted line in FIG. 15(b) are hardened and the upper portion of the black matrix BM and the upper portion of the pixel portions are held in the unhardened state. The height of the hardened dyed substrate DP is determined based on conditions similar to those of the above-mentioned embodiment.

Thereafter, as shown in FIG. 15(c), in the state that the dyed substrate DPX remains on the black matrix BM, the dye ink in respective colors INK (R), INK (G), INK (B) is supplied by an ink jet system to indentations (apertures) of the dyed substrate layer DP using the black matrix BM as partition walls. The dye ink is excessively supplied such that the dye ink is raised in the inside of the apertures due to its surface tension whereby the degree of dyeing sufficiently progress. FIG. 15(c) shows this state.

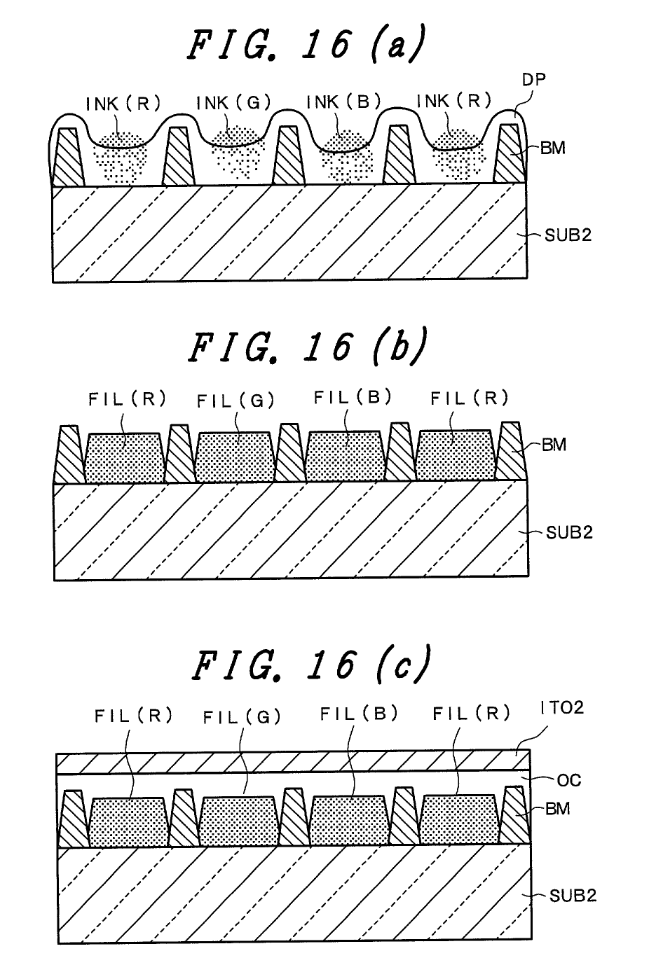

FIG. 16 shows an explanatory view of the dyeing step of this embodiment. The state that the dye supplied in the step shown in FIG. 15(c) permeates the dyed substrate layer and dyes this layer is shown in FIG. 16(a).

After supplying the dyes corresponding to the dyed substrate layers DP which are formed using the black matrix BM as partition walls, they are subjected to the dye diffusion step (dyeing step) such as heating so that respective pixels are dyed in given color tones and color density. This dyeing step may be performed in a method similar to the method described with respect to the first embodiment.

After dyeing respective pixels in given colors, the dyed substrate on the black matrix BM and the unhardened dyed substrate layer forming the upper layer of the dyed substrate layer DP are simultaneously removed (FIG. 16(b)). It is necessary to use a developer having a composition which prevents the dissolving of the colored dye from the pixel portion. Here, when the excessive dye remains, this excessive dye is also removed.

Thereafter, the crosslinking density is further increased by heating and then an overcoat layer OC is coated and hardened so as to realize the perfect separation from the neighboring pixels in the same manner as the previous embodiment. The color filter which is formed in this manner has a structure where the dyed substrate after dyeing is surrounded by three kinds of components which cannot be dyed consisting of the substrate, the black matrix and the overcoat and hence, the color filter having sufficient stability and reliability can be obtained.

Then, when the color filter is used in the liquid crystal display device of the IPS system, a liquid crystal orientation film is coated on the overcoat OC, while when the color filter is used in the liquid crystal display device of TN or the like, a transparent conductive film ITO2 is formed on the overcoat layer OC by vapor deposition and then a liquid crystal orientation control layer is coated on the conductive film ITO2 (FIG. 16(c)).

Subsequently, the fifth embodiment of a color filter manufacturing method of the present invention is explained hereinafter. In this embodiment, the supply of the dye in the fourth embodiment is performed before performing the back exposure and an upper layer of the dyed substrate layer and an unexposed dyed substrate disposed above an upper portion of the black matrix are developed and removed. Here, since the dyed substrate which is subjected to the back exposure has been already dyed, the absorption spectrum is different. Accordingly, in this embodiment, with respect to the dyed substrate which are dyed in respective colors, light having the wavelength whose light transmitting property agree with each other (for example, i rays) is used.

With the above-mentioned fourth and fifth embodiment, the color filters having given color tones can enhance the flatness of their upper surfaces so that the color filter substrate having a favorable surface flatness can be obtained with coating of the thin overcoat.

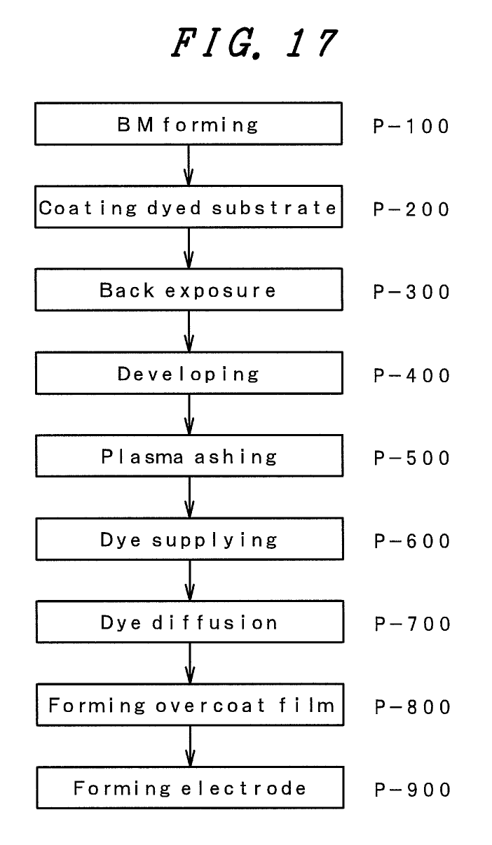

FIG. 17 is a schematic process view for explaining the sixth embodiment of a color filter manufacturing method of the present invention. In this embodiment, the wettablility between dyed substrate layers and dye when the dye is supplied to the dyed substrate layers by an ink jet method is enhanced so as to further suppress the occurrence of color irregularity.

In the state that the wettability between the dyed substrate layers and the dye is not favorable, when the dye is dropped on the dyed substrate layers, the dye is not made wet uniformly and this gives rise to the color irregularity. In this embodiment, as in the case of the previous embodiment, a black matrix BM is formed (P-100) and the dyed substrate is coated (P-200). As the dyed substrate, natural protein substance such as casein, gelatin or the like can be used. However, in this embodiment, for example, a “CFR-633” system material produced by Nihon Kayaku Kabushiki Kaisha which uses acrylic system resin as a base is suitable. This dyed substrate is subjected to the back exposure (P-300) for developing and the dyed substrate layers having a given thickness are formed (P-400).

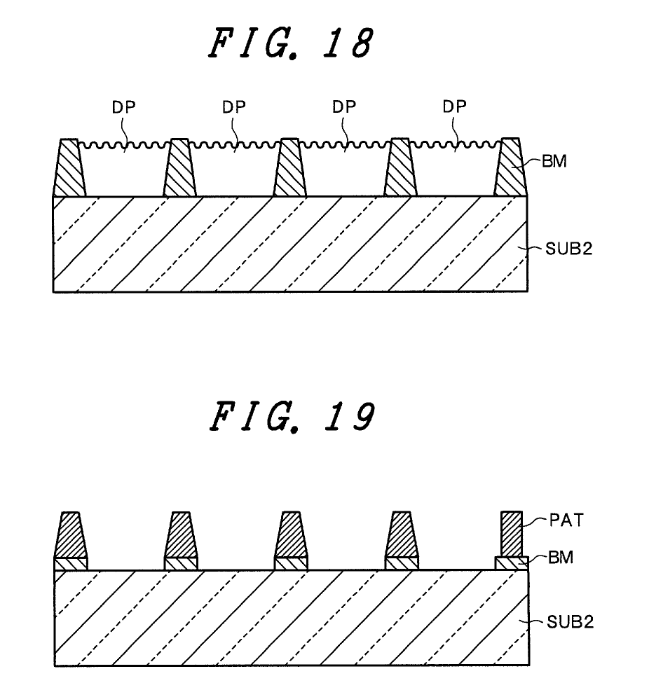

Ashing with plasma processing (plasma ashing) is applied to the surfaces of the dyed substrate layers so as to make the surfaces coarse (P-500). FIG. 18 is an explanatory view showing the dyed substrate layers whose surfaces are made coarse by the plasma ashing.

This plasma processing uses a plasma generating device which can introduce oxygen, nitrogen, air or the like as a gas and the substrate SUB2 on which the dyed substrate layers DP are formed is mounted. The conditions of this plasma ashing are set such that the pressure is 200 Pa, the output power is 500 W, the introduced gas is air, the flow rate of gas is 1.0 litter/min. By making the surfaces of the dyed substrate layers DP coarse, the wettability can be enhanced.

On the dyed substrate layers DP whose surfaces are made coarse, the dye is supplied and coated by the ink jet method (P-600). The dye is uniformly coated on the dyed substrate layers DP which is subjected to ashing and thereafter the diffusion treatment similar to that of the previous embodiment is applied to the dyed substrate layers DP so as to dye the dyed substrate layers DP (P-700).

Thereafter, a protective film (overcoat layer) is coated (P-800) and, when necessary, a transparent electrode (ITO) is formed by vapor deposition (P-900) and a liquid crystal orientation control film is coated to obtain a color filter substrate.

According to this embodiment, as in the case of the previous embodiments, by making the height (film thickness) of the dyed substrate layers lower than the height of the black matrix BM thus forming dye reservoirs, the degree of dyeing can be enhanced and, at the same time, by applying the plasma ashing to the dyed substrate layers, the dye can be uniformly diffused so that the color filter having high quality and free from color irregularity can be provided.

FIG. 19 is a schematic process view for explaining the seventh embodiment of a color filter manufacturing method of the present invention. In this embodiment, a black matrix BM is made of a metal film and the flow-out of dye from apertures of the black matrix BM is prevented thus eliminating the occurrence of mixed color of the neighboring pixels.

The black matrix BM constituted by a metal film made of chromium or the like is provided to a first main surface of a color filter substrate SUB2 and partition walls PAT made of resin are formed on the black matrix BM. By providing these partition walls PAT, when the dye is supplied to dyed substrate layers formed on apertures surrounded by the partition walls, the flow-out of the dye to the neighboring apertures can be prevented. Two methods which will be described hereinafter can be used for forming these partition walls.

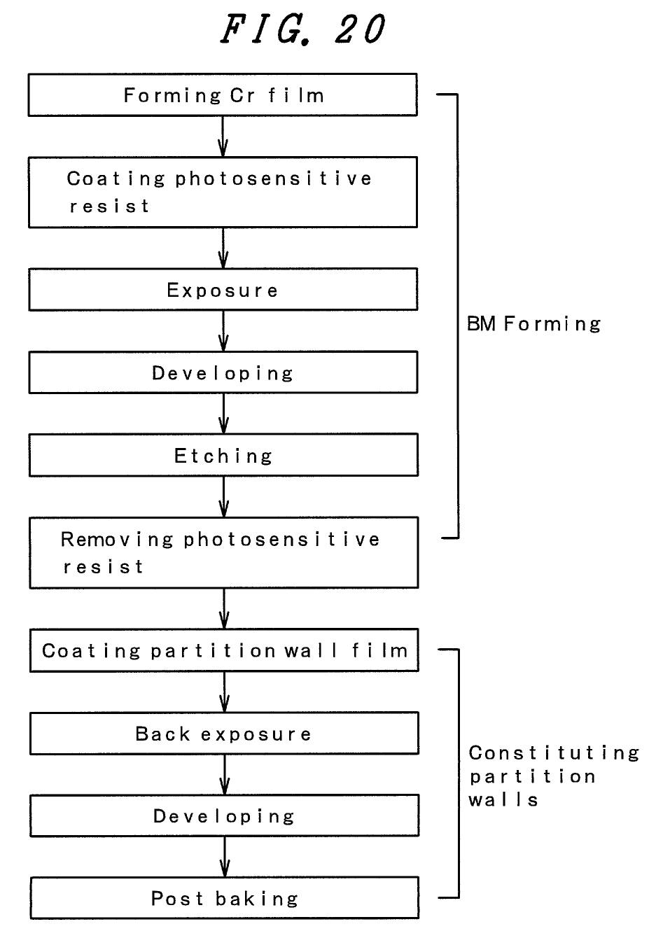

FIG. 20 is a schematic process view for explaining the first partition wall forming method according to the seventh embodiment of the present invention. First of all, on the whole surface of the substrate SUB2 shown in FIG. 19, a chromium film is formed. A negative-type photosensitive resist is coated and the resist is exposed by way of an exposure mask and then developed. Due to this developing, only portions of the photo resist which forms the black matrix remain and other portions of the photo resist is removed.

Then the wet etching or the dry etching treatment is performed so as to leave the portion of the chromium film disposed at a lower layer of the photo resist while removing other portions of the chromium film. By peeling off the photo resist, the black matrix BM made of the chromium film can be obtained. The above is the BM forming step shown in FIG. 20.

Subsequently, a positive-type photo resist (partition wall film) which covers the black matrix BM made of the chromium film and will constitutes partition walls is coated and thereafter the back exposure is performed from the substrate SUB2 side using the black matrix BM as an exposure mask.

By developing this, the exposed portion of the positive-type photo resist is removed so that the partition walls PAT made of the resist are formed on the black matrix BM. The above constitutes a partition wall forming step shown in FIG. 20.

In this manner, the black matrix BM having the partition walls PAT mounted thereon are formed on the substrate SUB2, and apertures surrounded by the partition walls PAT are defined as pixel regions, and a dyed substrate is coated on the pixel regions and then dye is supplied to the dyed substrate to dye the dyed substrate or dyed substrate layers are formed and thereafter the dye is supplied to the dyed substrate layers.

The manner of forming these dyed substrate and the dyed substrate layer and the treatment before and after the dyeing are performed in the similar manner as those of the previously-mentioned embodiments which use the dye so as to obtain the color filter.

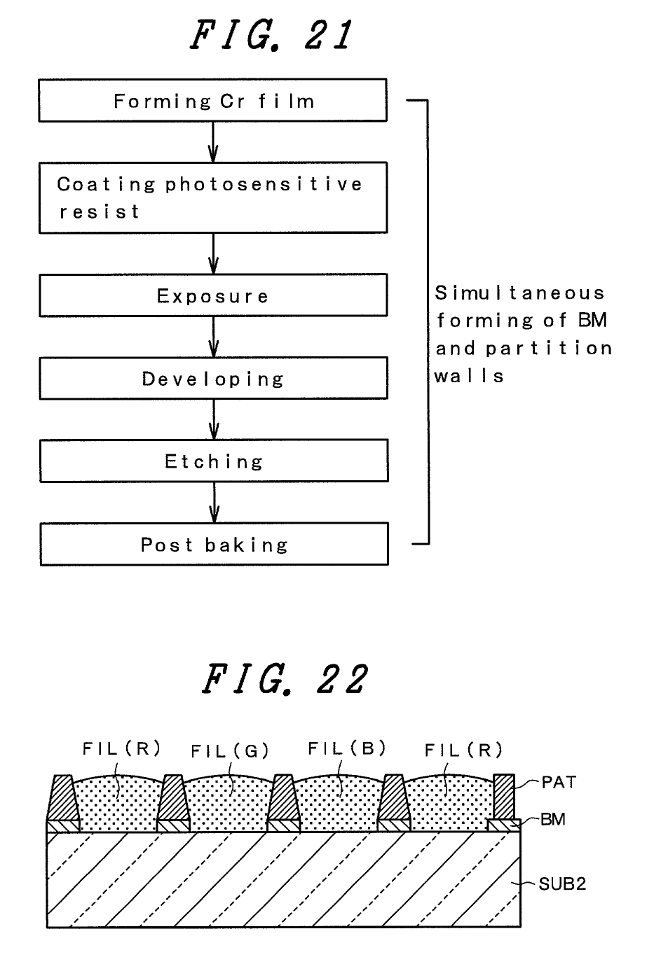

FIG. 21 is a schematic process view for explaining the second partition wall forming method according to the seventh embodiment of the present invention. First of all, on the whole surface of the substrate SUB2 shown in FIG. 19, a chromium film is formed. A negative-type photosensitive resist is coated and the resist is exposed by way of an exposure mask and then developed. Due to this developing, only portions of the photo resist which form the black matrix remain and other portions of the photo resist is removed.

Then, the wet etching or the dry etching treatment is performed so as to leave the portion of the chromium film disposed as a lower layer of the photo resist while removing other portions of the chromium film. Subsequently, photo resist is subjected to post baking to make the photo resist hardened. Accordingly, a substrate which has partition walls PAT made of resin on the black matrix BM made of the chromium film can be obtained.

Then, in the same manner as mentioned above, apertures surrounded by the partition walls PAT are defined as pixel regions, and the dyed substrate is coated on the pixel regions and then dye is supplied to the dyed substrate to dye the dyed substrate or dyed substrate layers are formed and thereafter the dye is supplied to the dyed substrate layers.

FIG. 22 is a schematic cross-sectional view of a color filter obtained by forming the dyed substrate layers on the substrate having partition walls of the embodiment shown in FIG. 19 and then dyeing the dyed substrate layers with the dye. Respective color filters FIL (R), FIL (G), FIL (B) are separated by the partition walls PAT thus providing the color filter substrate having high quality which is free from the mixed color.

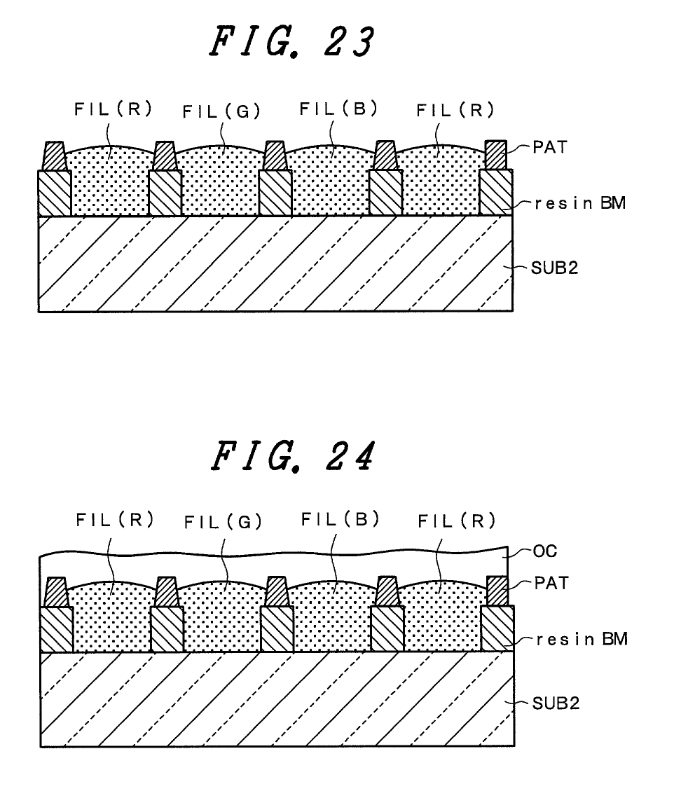

FIG. 23 is a schematic cross-sectional view for explaining a color filter substrate of the eighth embodiment of the present invention. This embodiment is characterized in that partition walls made of resin are mounted on a black matrix BM made of resin. The resin-made black matrix BM is formed by a method similar to the conventional method. A positive-type photo resist (partition wall film) is coated on the black matrix BM and thereafter, the back exposure is performed from the substrate SUB2 side using the black matrix BM as the exposure mask.

By developing this, the exposed portion of the positive-type photo resist is removed so that the partition walls PAT made of the resist are formed on the black matrix BM.

With respect to the substrate SUS2 which are formed in the above manner and has the partition walls PAT on the black matrix BM, apertures surrounded by the partition walls PAT are defined as pixel regions, and a dyed substrate is coated on the pixel regions and then dye is supplied to the dyed substrate to dye the dyed substrate or dyed substrate layers are formed and thereafter the dye is supplied to the dyed substrate layers.

The manner of forming these dyed substrate and the dyed substrate layer and the treatment before and after the dyeing are performed in the similar manner as those of the previously-mentioned embodiments which use the dye so as to obtain the color filter.

FIG. 24 is a schematic cross-sectional view showing the state that color filters are formed in apertures of the black matrix having partition walls as explained in conjunction with FIG. 23 and an overcoat OC is coated on the color filters. With the provision of these partition walls PAT, when the dye is supplied to the dyed substrate layers formed in the apertures surrounded by the partition walls, the flow-out of the dye to the neighboring apertures can be prevented so that the color filter substrate free from the mixed color can be obtained.

Thereafter, when the color filter substrate is for the IPS type liquid crystal display device, a liquid crystal orientation control film is coated on the overcoat layer OC to obtain the color filter substrate, while when the color filter substrate is for the STN or TN type liquid crystal display device, a transparent conductive film is formed on the overcoat layer OC and a liquid crystal orientation control film is coated on the transparent conductive film to obtain the color filter substrate.

Further, the color filter which constitutes the color filter substrate having a shape shown in FIG. 22 and FIG. 23 can be formed by coating colored resin (color resist) and using the photolithography. Since the method which uses respective color resists is equal to the method applied to the second embodiment, the explanation thereof is omitted.

With the use of the color filter substrate having the above-mentioned constitution, the liquid crystal display device having high display quality and high reliability can be obtained.

In the above-mentioned embodiments, the supply of the dye liquid or the colored dyed substrate is performed by the ink jet system. However, for example, as means for supplying a suitable amount of dye liquid (ink) to every pixels, a dispenser provided with a nozzle or a syringe provided with a hollow needle may be used in place of the above-mentioned ink jet method to exercise the present invention.

This is because that problems such as color irregularity which occurs in the color filter manufacturing step using the conventional ink jet method which has been explained heretofore may occur in the steps for dropping a given amount of dyeing liquid for every pixels using the nozzle or the hollow needle.

As the previously mentioned dispenser, a device which is used in coating a sealing agent for a liquid crystal panel is known. However, in the manufacturing the color filters, it is recommendable to use a device called micro dispensers which can meet the micro processing.

Further, a method which supplies a given amount of liquid substance by means of an ink jet method or a micro dispenser or the like may be applicable not only to the dyeing liquid but also to a coloring substrate (being in the liquid state before being hardened).

Subsequently, the constitution of a liquid crystal display device using the above-mentioned color filter substrate is explained hereinafter taking a TN type thin film transistor type liquid crystal display device as an example.

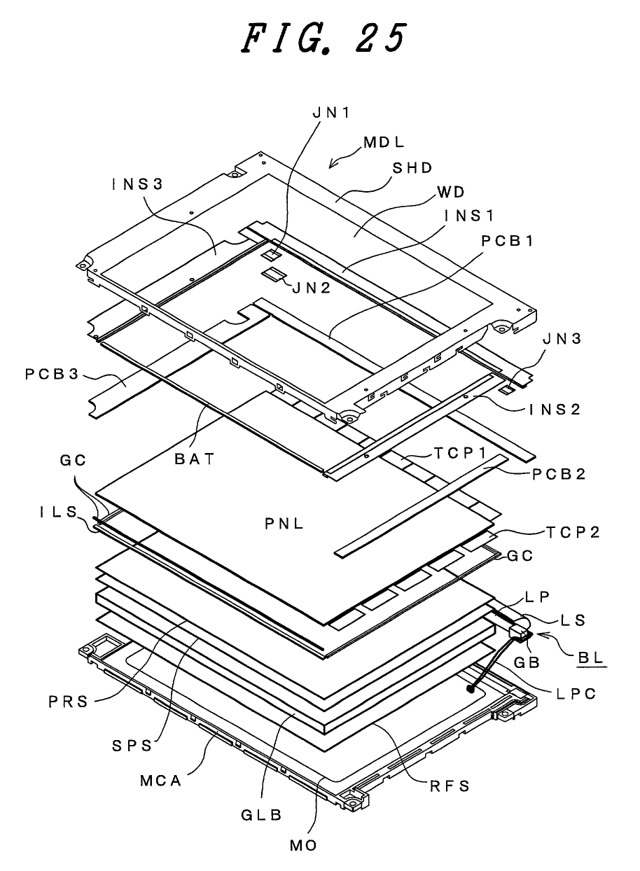

FIG. 25 is a developed perspective view for explaining one constitutional example of a liquid crystal display device to which the present invention is applied. That is, FIG. 25 shows a so-called liquid crystal display device (liquid crystal display module) which incorporates a backlight and the like into a liquid crystal panel on which a drive circuit is mounted. In the drawing, SHD indicates an upper frame, WD indicates a display window, PNL indicates a liquid crystal panel which is comprised of a color filter substrate having a color filter structure explained in the previous embodiments and a thin film transistor substrate having thin film transistors, SPS indicates a light diffusion plate, GLB indicates a light guide body, RFS indicates a reflection plate, BL indicates a back light, MCA indicates a lower frame. Respective members are stacked in the vertical arrangement relationship shown in the drawing to assemble the liquid crystal display module MDL.

The liquid crystal display module MDL is constituted such that the whole is fixedly secured by engaging a pawl formed on an upper frame SHD with a hook formed in the lower frame MCA.

In the periphery of the upper frame SHD, drive circuit boards (a gate side circuit board, a drain side circuit board) PCB1, PCB2, an interface circuit board PCB3 are connected to the liquid crystal panel PNL and circuit boards are connected with each other by means of tape carrier pads TCP1, TCP2, or joiners JN1, JN2, JN3.

The lower frame MCA is constituted such that a light diffusion sheet SPS, a light guide body GLB and a reflection plate RFS which constitute a backlight BL are accommodated in an opening MO of the lower frame MCA. On a side surface of the light guide body GLB, a linear lamp (fluorescent lamp) LP is arranged. The light irradiated from this linear lamp LP is irradiated as a uniform lighting light to the liquid crystal panel PNL side through the light guide body GLB, the reflection plate RFS and the light diffusion plate SPS. LS indicates a reflection sheet provided to the fluorescent lamp LP.

Between the backlight BL and the liquid crystal panel PNL, a prism sheet PRS for adjusting the advancing path of the lighting light is laminated by way of a light shielding spacer ILS.

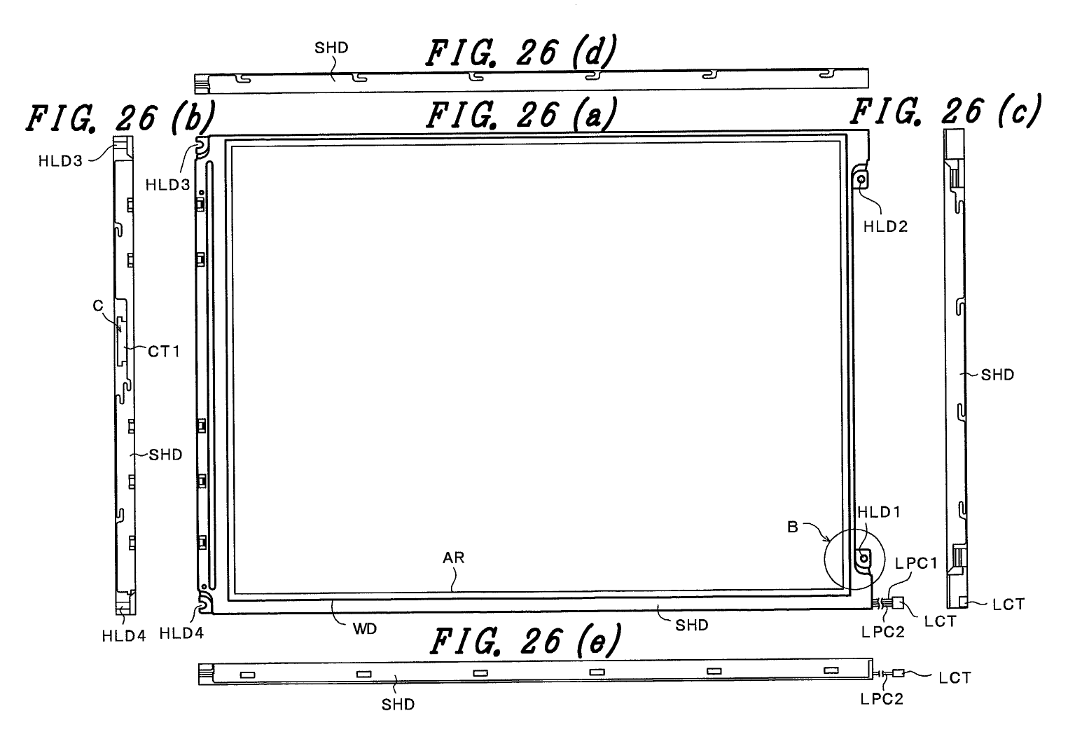

FIG. 26 is an explanatory view of an profile structure of the liquid crystal display module which is formed by integrating the liquid crystal panel which constitutes the liquid crystal display device together with the backlight by means of the upper frame and the lower frame. In the drawing, (A) is a plan view of the display side, (B) is a left side view, (C) is a right side view, (D) is an upper-side side view and (E) is a lower-side side view.

In the drawing, SHD indicates the upper frame, AR indicates a display region, HLD 1-4 indicate mounting holes, LCT indicates connection connectors. LPC1 indicates a lamp cable, CT1 indicates an interface connector, WD indicates an opening which exposes the display region. Further, POL indicates an upper polarizer (POL2) and is adhered to cover the upper surface of the liquid crystal panel PNL.

This liquid crystal display device is incorporated by using two kinds of accommodating/holding members comprising the upper frame SHD and the lower frame MCA. The liquid crystal display device is mounted on a display part of an information processing apparatus such as a notebook personal computer or a monitor or the like using mounting holes HLD 1-4.

Into a recessed portion disposed between the mounting holes HLD1 and HLD2, an inverter for backlight is incorporated and the inverter supplies an electric power to the linear lamp (fluorescent lamp) which constitutes the backlight assembly together with a connection connector LCT and a lamp cable LPC1. In this embodiment, the fluorescent lamp is incorporated into the rear lower side of the liquid crystal panel PNL.

Signals from a main computer (host) and a necessary power supply are supplied through an interface connector CT1 positioned at the rear surface.

The liquid crystal display device shown in the drawing has a large outer diameter size, wherein in spite of the fact the display region AR is enlarged, a so-called frame region which does not contribute to the displaying is made small. Further, the weight is reduced. Accordingly, with such liquid crystal display device, the large-sized screen which viewers can easily watch can be obtained without losing the portability of the movable type information processing apparatus.

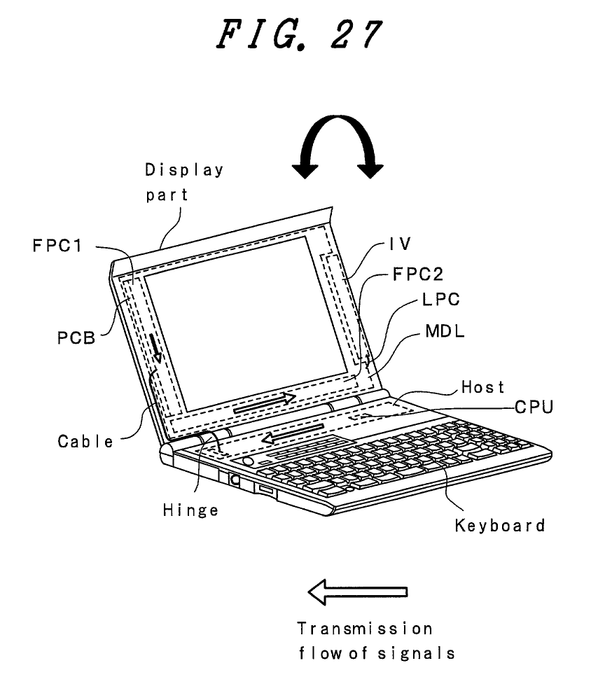

FIG. 27 is a perspective view of a notebook type computer for explaining a mounting example of a liquid crystal display device shown in FIG. 26. This notebook type computer (portable computer) is comprised of a keyboard portion (body part) and a display part which is connected to the keyboard part by means of a hinge. Signal generating functions such as a keyboard and a host (host computer) or CPU and the like are stored in the keyboard part. A liquid crystal panel PNL is included in a case CASE of a display part. On the periphery of the liquid crystal display panel, drive circuit boards FPC1, FPC2, a PCB which mounts a control chip TCON thereon and an inverter power supply board IV which is a backlight power supply and the like are mounted.

Then, the liquid crystal display module which integrates such liquid crystal panel PNL, various circuit boards FPC1, FPC2, PCB, the inverter power supply board IV, and the backlight is fixedly secured to the display part by the above-explained structure.

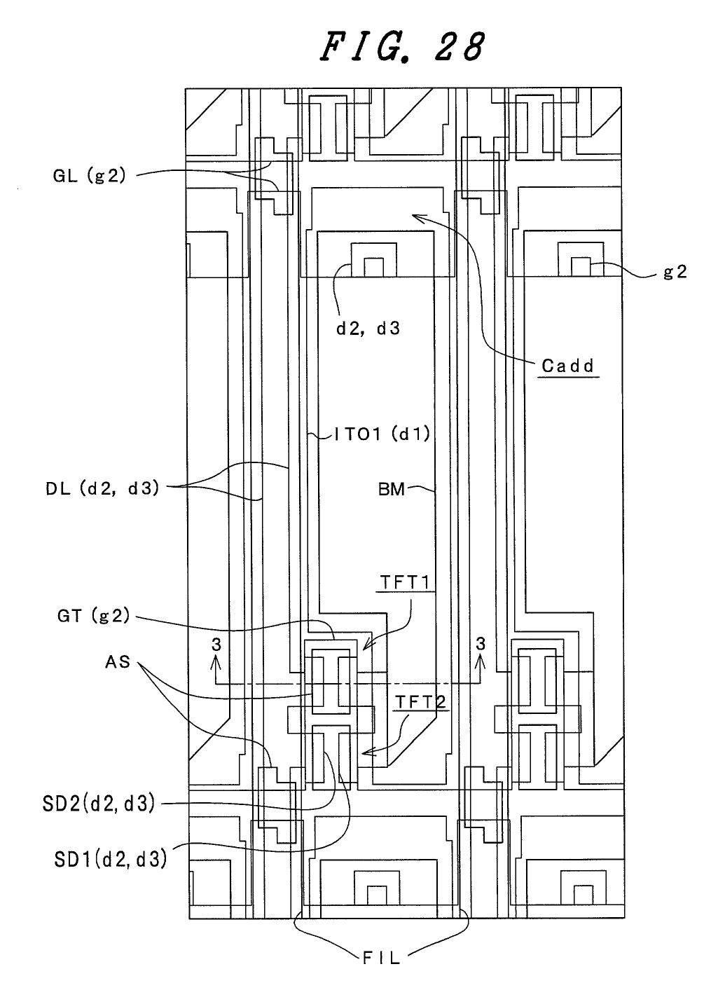

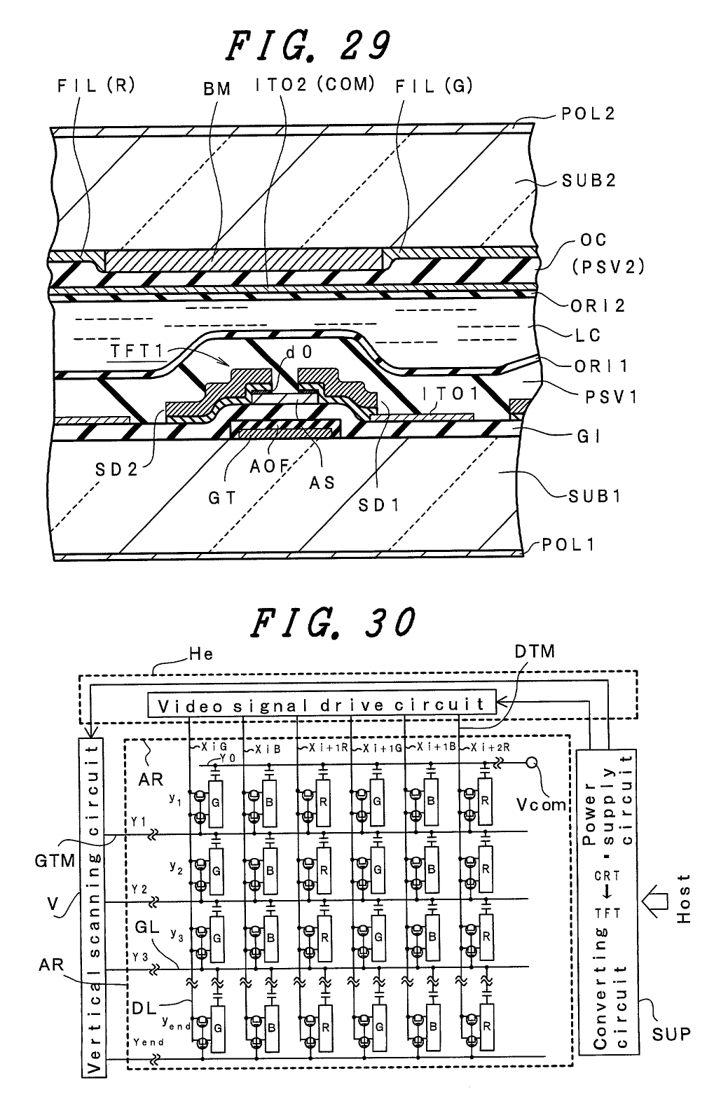

FIG. 28 is a plan view for explaining one pixel and the constitution around the pixel of a thin film transistor type liquid crystal display device to which the present invention is applied. FIG. 29 is a cross-sectional view taken along a line 3-3 of FIG. 28.

As shown in FIG. 28, each pixel is arranged in a region (in the region surrounded by four signal lines) where two neighboring scanning signal lines (gate signal lines or horizontal signal lines) GL and two neighboring video signal lines (drain signal lines or vertical signal lines) DL intersect.

Each pixel includes a thin film transistor TFT, a transparent pixel electrode ITO1 and a hold capacity element Cadd. The scanning signal lines GL extend in the column direction and are arranged in the row direction in plural numbers. The video signal lines DL extend in the row direction and are arranged in the column direction in plural numbers.

As shown in FIG. 29, provided that a liquid crystal LC is set as reference, at the lower transparent glass substrate (thin film transistor substrate) SUB1 side, a thin film transistor TFT and a transparent pixel electrode ITO1 are formed. The lower transparent glass substrate SUB1 includes a thin film transistor TFT which is made of a gate electrode GT, a semiconductor layer AS, a source electrode SD1 and a drain electrode SD2.

In the drawing, AOF indicates a protective film, GI indicates a gate insulation film, d0 indicates a contact layer, and PSV1 indicates a passivation layer (protective layer).

On the upper transparent glass substrate (color filter substrate) SUB2 side, a color filter FIL, a black matrix BM, an overcoat layer OC (passivation layer PSV2), a transparent electrode (supply electrode COM) ITO2 and a liquid crystal orientation control layer (orientation film) ORI2 are formed. The upper and lower transparent glass substrates SUB2, 1, for example, have a thickness of an approximately 1.1 mm or approximately 0.7 mm.

That is, on the inside (first main surface) of the upper transparent glass substrate SUB2, the color filters FIL (only red filter FIL (R) and green filter FIL (G) being shown) which use the black matrix BM as partition walls and the upper orientation films ORI2 are laminated in order. The color filters formed on the color filter substrate SUB2 which constitutes the upper transparent glass substrate are filters which are manufactured in one of the embodiments of the present invention.

FIG. 30 is a wiring diagram of an equivalent circuit of the liquid crystal display device and a peripheral circuit. Although this drawing is a circuit diagram, the diagram is drawn corresponding to the actual geometric arrangement. AR indicates a matrix array which constitutes a display part where a plurality of pixels were arranged in a two-dimensional manner.

In the drawing, X means video signal lines DL, suffix G, B and R are affixed respectively corresponding to green, blue and red pixels. Y means scanning signal lines GL and suffix 1, 2, 3 . . . , end are affixed in accordance with the sequence of the scanning timing.

The video signal lines X (suffix omitted) are connected to an upper video signal drive circuit He. That is, with respect to the video signal lines X, in the same manner as the scanning signal lines Y, their terminals are pulled out from only one side of the liquid crystal panel PNL. The scanning signal lines Y (suffix omitted) are connected to a vertical scanning circuit V.

SUP indicates a circuit which includes a power supply circuit for obtaining stabilized voltage sources by dividing one voltage source in a plural number and a circuit which converts information for CRT (cathode ray tube) from a host (upper arithmetic processing apparatus) into information for TFT liquid crystal display device.

According to the above-mentioned liquid crystal display device of the present invention, the liquid crystal display device which realizes the image display having high quality and free from mixed color can be obtained.

As has been explained heretofore, the present invention can solve problems which the conventional techniques have with respect to the color resist method or the dyeing method using an ink jet method and can provide a method for manufacturing color filters which have uniform color tones and a favorable surface flatness and a liquid crystal display device which adopts such color filters.

What is claimed is:

1. A method for manufacturing color filters characterized by performing following steps in sequence;
a first step in which on an upper portion of a first main surface of a substrate used in a liquid crystal display device, a resin film having a lower light transmitting property than the substrate is formed and a plurality of apertures are formed in the resin film in a spaced-apart manner from each other,
a second step in which a material having a higher light transmitting property than the resin film and being hardened by the irradiation of light is coated on the resin film,
a third step in which light is irradiated from a second main surface opposite to the first main surface of the substrate and hardens portions of the material,
a fourth step in which the material other than the hardened portions is removed, and
a fifth step in which dye is supplied to every apertures of the resin film and is made to permeate into the material formed for every apertures.

2. A method for manufacturing color filters according to claim 1, wherein the supply of the dye in the fifth step is performed by an ink jet method.

3. A method for manufacturing color filters according to claim 2, wherein dyes different in color for every apertures are supplied by the ink jet method.

4. A method for manufacturing color filters according to claim 1, wherein the supply of the dye in the fifth step is performed in sequence for every one of dyes in a plurality of colors.

5. A method for manufacturing color filters comprising
a first step in which on an upper portion of a first main surface of a substrate used in a liquid crystal display device, a resin film having a lower light transmitting property than the substrate is formed and a plurality of apertures are formed in the resin film in a spaced-apart manner from each other,
a second step in which three kinds of materials having a higher light transmitting property than the light shielding resin film and being hardened by the irradiation of light and being different in color are supplied to the resin film for every apertures,
a third step in which light is irradiated from a second main surface opposite to the first main surface of the substrate and hardens portions of the material, and
a fourth step in which the material other than the hardened portions is removed such that the height of the material formed for each aperture becomes lower than the height of the resin film at least at a central portion of the aperture.

6. A liquid crystal display device including a pair of substrates having respective main surfaces thereof arranged such that the main surfaces face each other in an opposed manner, a liquid crystal layer sandwiched between the respective main surfaces of a pair of substrates, a first film formed on the main surface of one of a pair of substrates and having a plurality of apertures spaced apart from each other and being made of a first material having a lower light transmittance than a pair of substrates, and second films formed in the apertures of the first film and being made of a second material having a higher light transmittance than the first material,
the second films include at least one of three kinds of dyeing materials different in color for every apertures of the first film and are classified into three groups consisting of a first kind group, a second kind group and a third kind group corresponding to kinds of the containing dyeing materials,
the first kind group and the second kind group of the second film include regions in the inside of the apertures of the first film which are thinner than the first film which forms the apertures,
the third kind group of the second film includes regions within the apertures of the first film which are thicker than the first film which forms the apertures, and
the thickness of at least one kind group of the second film in the inside of apertures of the first film is made different from the thickness of the other kind groups of the second film.

7. A liquid crystal display device includes a pair of substrates having respective main surfaces thereof arranged such that the main surfaces face each other in an opposed manner, a liquid crystal layer sandwiched between the respective main surfaces of a pair of the substrates, a first film formed on the main surface of one of a pair of substrates and having a plurality of apertures spaced apart from each other and being made of a first material having a lower light transmittance than a pair of these substrates, second films formed in apertures of the first film and being made of a second material having a higher light transmittance than the first material, and a third film formed by covering upper surfaces of the first and second films and having a higher light transmittance than the first film,
the second films include at least one of three kinds of dyeing materials different in color for every apertures of the first film and is classified into three groups consisting of a first kind group, a second kind group and third kind group corresponding to kind of the containing dyeing material,
at least one kind group of the second film includes regions in the inside of the apertures of the first film which are thinner than the first film which forms the apertures, the first kind group of the second film has the thickness thereof in the inside of the aperture of the first film different from the thickness of other kind groups of the second film, and the thickness of the third film on the first film is made thinner than the thickness of the first film.

8. A liquid crystal display device according to claim 6 or claim 7, wherein the thickness of the first film in the inside of the aperture is set to the maximum thickness of at least one kind group of the second film in the inside of the aperture.

9. A liquid crystal display device according to any one of preceding claim 6 to claim 8, wherein the undulation of an upper surface of the third film is set smaller than the undulation of the upper surfaces of the first film and the second film.
